(19) United States
(12) Patent Application Publication
(10) Pub. No.: US 2024/0290597 A1
(43) Pub. Date: Aug. 29, 2024

(54) IMPROVEMENTS IN AND RELATING TO ION ANALYSIS

(71) Applicant: SHIMADZU CORPORATION, Kyoto-Shi (JP)

(72) Inventors: Sergey SMIRNOV, Leigh (GB); Li DING, Ningbo (CN); Aleksandr RUSINOV, Altrincham (GB)

(21) Appl. No.: 18/567,194

(22) PCT Filed: Jun. 15, 2021
(86) PCT No.: PCT/EP2021/066101

§ 371 Date: Dec. 5, 2023

(51) Int. Cl. H01J 49/00; H01J 49/02; H01J 49/42

(52) U.S. Cl. CPC H01J 49/0036; H01J 49/0004; H01J 49/027; H01J 49/425

(57) ABSTRACT

A method of processing an image-charge/current signal representative of one or more ions undergoing oscillatory motion within an ion analyser apparatus, the method comprising obtaining a recording of the image-charge/current signal generated by the ion analyser apparatus in the time domain. By a signal processing unit, the method includes selecting N (where N is an integer>1) separate values (OPₙ, where n=1 to N; N≥M) of the frequency-domain spectrum of the image-charge/current signal each from amongst a plurality of spectral peaks which include a harmonic peak associated with a target ion. By solving a system of equations:

$${OP}_{n} = {\sum }_{m = 1}^{N} {α}_{n m} \times {TP}_{m} ,$$

$$for n = 1 to N ;$$

$$N \geq M$$

where αₙₘ are coefficients and TPₘ are corrected values of the spectrum, the charge of the target ion is determined based on a magnitude of a corrected value(s) (TPₘ) associated with that ion.

### FIELD OF THE INVENTION

The present invention relates to methods and apparatus for ion analysis using image-charge/current analysis and an ion analyser apparatus therefor. Particularly, although not exclusively, the invention relates to analysis of image-charge/current signals for determining the charge of an ion. For example, image-charge/current signals may be generated by an ion mobility analyser, a charge detection mass spectrometer (CDMS) or an ion trap apparatus such as: an ion cyclotron, an Orbitrap®, an electrostatic linear ion trap (ELIT), a quadrupole ion trap, an Orbital Frequency Analyser (OFA), a Planar Electrostatic Ion Trap (PEIT), or other ion analyser apparatus for generating oscillatory motion therein.

### BACKGROUND

In general, an ion trap mass spectrometer works by trapping ions such that the trapped ions undergo oscillatory motion, e.g. backwards and forwards along a linear path or in looped orbits. An ion trap mass spectrometer may produce a magnetic field, an electrodynamic field or an electrostatic field, or a combination of such fields to trap ions. If ions are trapped using an electrostatic field, the ion trap mass spectrometer is commonly referred to as an “electrostatic” ion trap mass spectrometer.

In general, the frequency of oscillation of trapped ions in an ion trap mass spectrometer is dependent on the mass-to-charge (m/z) ratio of the ions, since ions with large m/z ratios generally take longer to perform an oscillation compared with ions with small m/z ratios. Using an image-charge/current detector, it is possible to obtain, non-destructively, an image charge/current signal representative of trapped ions undergoing oscillatory motion in the time domain. This image-charge/current signal can be converted to the frequency domain e.g. using a Fourier transform (FT). Since the frequency of oscillation of trapped ions is dependent on m/z, an image-charge/current signal in the frequency domain can be viewed as mass spectrum data providing information regarding the m/z distribution of the ions that have been trapped.

In mass spectrometry, one or more ions undergoing oscillatory motion within an ion analyser apparatus (e.g. an ion trap) may induce an image-charge/current signal detectable by sensor electrodes of the apparatus configured for this purpose. A well-established method for analysing such an image-charge/current signal is to perform a transformation of that time-domain signal into the frequency domain. The most popular transformation for this purpose is the Fourier transformation (FT). Fourier transformations decompose a time-domain signal into sinusoidal components, each component having a specific frequency (or period), amplitude and phase. These parameters are related to the frequency (or period), amplitude and phase of periodic components (frequency components) present in the measured image-charge/current signal. The frequency (or period) of those periodic components can be easily related to the m/z value of the respective ion species or to its mass if its charge state is known. Mass spectrometers utilizing these principles are called Fourier Transform Mass Spectrometers, and the field itself is called Fourier Transform Mass Spectrometry (FTMS).

Two popular FTMS ion traps are the Fourier Transform Ion Cyclotron Resonance trap (FTICR) and the Orbitrap® The former uses magnetic fields to trap ions, while the latter uses electrostatic fields to trap ions. Both traps generate harmonic image-charge/current signals. Other types of FTMS ion traps are configured to generate non-harmonic image-charge/current signals. FTICR typically employs a superconductor magnetic field for ion trapping, whereas in an Orbitrap®, ions are trapped by an electrostatic field so as to cycle around a central electrode in spiral trajectories. Another known example of ion trap mass spectrometer is the Orbital Frequency Analyser (OFA) described in: “High-Capacity Electrostatic Ion Trap with Mass Resolving Power Boosted by High-Order Harmonics”: by Li Ding and Aleksandr Rusinov, Anal. Chem. 2019, 91, 12, 7595-7602. Yet another known example of ion trap mass spectrometer is the Electrostatic Ion Beam Trap (“EIBT”) disclosed in WO02/103747 (A1), by Zajfman et al. In an EIBT, ions generally oscillate backwards and forwards along a linear path, so such an ion trap is also referred to as an “Electrostatic Linear Ion Trap” (ELIT).

Analysis of non-harmonic image-charge/current signals also can be performed using the Fourier transformation, and doing so will generate multiple harmonics for each periodic/frequency component of the image-charge/current signal. However, harmonics of different orders can mix (overlap) with each other within the frequency spectrum of the Fourier transformed image-charge/current signal, and this makes it much more difficult to relate the frequency of components to the mass-to-charge ratio (m/z) or mass of ion species.

Charge detection mass spectrometry uses the signal from ion motion in an ion trap to measure the m/z and the charge simultaneously for an individual ion. The ion trap may be in the form of an Ion Cyclotron Resonance (ICR) cell, an Orbitrap or other kind of electrostatic ion trap such as the electrostatic linear trap, the electrostatic planar trap (OFA) and the Cassinian trap. After ions are introduced into the ion trap, they orbit or fly back and forth repeatedly in the trapping space and the oscillation or orbit frequency depends on the m/z of each ion. One or some of the electrodes in the ion trap plays a role of picking up the image charge signal from the ion motion. Such a signal may be harmonic having the waveform in the form of a sinusoidal wave, or otherwise it may be non-harmonic which means it has one or more significant harmonic frequency components in addition to its fundamental harmonic component (e.g. other frequency components, e.g. higher order harmonic frequency components). In any case, the repetition frequency of the signal will be the same or a multiple that the oscillation or orbit frequency. The amplitude of the signal however, is proportional to the charge of the ion.

When multiply charged ions are involved, especially the highly charged biological ions generated from an electrospray ion source and introduced into the ion trap, the signal from an individual oscillating ion can be detected, although certain signal processing algorithms must be used to suppress noise. One of the popular methods/algorithms used is the Fourier transform and this is the fundamental technology of so called Fourier transform mass spectrometry (FTMS).

In FTMS the frequency of ion motion can be measured very accurately when the recorded signal transient image-charge/current signal is long enough (say 1 s long). However the measurement of the charge of the ion is difficult. The amplitude of the signal is distorted by the electronic noise in the signal, and oscillation of the ion in the trap can also be interrupted by collision with residual gas molecules, space charge interaction between ions, or signal interference when multiple ions are flying together. To reduce these problems, one needs to inject a limited number of ions in each cycle (normally limited to tens to hundreds), pump the system to ultra-high vacuum (around or below 10⁻¹⁰ torr) and improve the signal-to-noise ratio (S/N) of signal pick-up and amplifier system.

From the point of view of hardware, currently the charge measurement error can reach ‘2e’, where ‘e’ is the electron charge, with an electrostatic ion trap with very good vacuum and a transient length of about 1s. In software used to process the recorded transient image-charge/current signal, it is important to accurately determine the frequencies in the signal, which implies how many ions are present and their m/z involved in the signal. This is done normally by applying fast Fourier Transform (FFT). The lifetime of each ion, or the duration of time that the oscillation of ion has not been interrupted by collision, must also be determined. The prior art STORI slope method may be used to try to determine the lifetime (LT) and the charge of the ion afterwords.

The STORI method [Jared O. Kafader, “STORI Plots Enable Accurate Tracking of Individual Ion Signals”; J. Am. Soc. Mass Spectrum (2019) 30: 2200-2203] provides a means of finding the lifetime of ion oscillation. This method calculates a quantity:

$$S ( {t}_{n} ) = {\sum }_{t = 0}^{{t}_{n}} f ( t ) {e}^{- 2 π {iv}_{0} t}$$

from an image-charge/current signal, f(t), which increases generally linearly over time while an ion oscillation continues to generate a detectable signal. The average slope of growth of the increasing value of S(t), the STORI function, can depend on the amplitude of the image-charge/current signal and may be proportional to the charge of an ion under favourable circumstances. By measuring the slope of STORI function under favourable circumstances, the charge of ion can be determined. When the image charge signal ceases (i.e. the ion is neutralised, or abruptly changes its frequency) the linear growth of the STORI function also ceases and, ideally, remains constant afterwards. This property allows one to determine when the ion ceased and gives information of the ion's lifetime. FIG. 1a shows a theoretical, idealised form of a STORI function. It is found that the form of the STORI function is linear ‘on average’ (e.g. there might be some undulations that depend on how the frequency of the ion relates to the sampling frequency) so that the rate of change of the magnitude of the function, S(tₙ), (i.e. the slope of the growth of the accumulated function S(tₙ)) within the data acquisition time interval, is proportional to the charge, z, of the ion:

$$\frac{dS ( {t}_{n} )}{dt} = a z + b$$

Here the terms ‘a’ and ‘b’ are constant, predetermined calibration values. The charge, z, of the ion may be determined according to this equation. The method may include determining a value of the charge of the ion(s) according to the rate of change (i.e. ‘slope’ of rise) of the magnitude of the accumulated function, S(tₙ).

However, the STORI method will mainly suit the case of harmonic oscillation, or more specifically when the image-charge/current signal generated from ion motion has a sinusoidal waveform. For a non-harmonic signal which contains multiple harmonic components, this method does not efficiently make use of these harmonic components and, thus, results in a lower signal to noise ratio or poor charge measurement accuracy. In addition, when calculating the value of the ion's charge, this method will suffer the influence of electronic noise embedded in the signal. When there are multiple ions coexisting in the ion trap during data acquisition, if the frequencies of ion oscillations are close enough they will start to interfere with each other further increasing the inaccuracy of charge measurement.

To illustrate problems associated with the STORI method, consider the following simulated test data shown in FIG. 1b. This figure shows two groups of STORI plots according to the prior art. A first group (curve 1) shows a STORI plot for an image-charge/current signal for a single ion and contains no noise or interference from other ions. A second group (curves 2, 3 and 4) show a STORI plots for a image-charge/current signals for a target ion and these plots contain realistic levels of noise or interference from other ions. Curve 1 was produced by a single ion oscillating at 170,000.00 Hz for the whole length of the signal. The total signal duration was 1,000 ms. The curve is a purely straight line and is an idealised result that almost never occurs in reality. Whether the line is straight depends on how the sampling frequency relates to the signal frequency and phase. A perfectly straight line, as in curve 1 in FIG. 1b, occurs only when the sampling period is an integer multiple of the signal period. Here ‘sampling’ relates to the distance between successive time points (tₙ) in the above STORI formula. Much more realistic are curves 2, 3 and 4 which represent the STORI plots for oscillations of three different ions of the same charge. Curve 2 corresponds to an ion oscillating at a frequency of 170,000.00 Hz (Ion #1), Curve 3 corresponds to an ion oscillating at a frequency of 170,010.95 Hz (Ion #2). Curve 4 corresponds to an ion oscillating at a frequency of and 170,006.57 Hz (Ion #3). Ion #2 lives for 200 ms and then changes its frequency to 170,050.11 Hz. Ion #3 lives for 300 ms and then changes its frequency to 170,008.76 Hz. The total signal duration is 1,000 ms for all three ions, and all three ions, even after changing their frequencies, have the same charge of 50e.

The slope of each of the STORI is assumed to be proportional to the charge of the ion producing it. The slope of the idealised ion (curve 1) represents the charge of 50e. The proportionality coefficient (gradient) of this curve may be used as calibration to estimate the charges of other ions. One problem is that, in the absence of the idealised curve 1, one must use the next best (‘most linear’) curve, such as curve 2, as calibration. Curve 2 is clearly modulated by oscillations that are clearly periodic, which means they are not produced by the noise, and estimating its slope is problematic.

Another problem with the STORI method is that it can only be used while the oscillation of the ion exists and is clear and present in the corresponding curve of the STORI plot for that ion as a rising linear (or quasi-linear) plot. When ion oscillation ceases, and the ‘lifetime’ of the ion oscillation has expired, the corresponding parts of the data on the STORI plot should, theoretically at least, cease to continue rising. One should not use any part of the STORI data corresponding to times after the end of this ‘lifetime’, in STORI analysis. However, it is often very difficult to accurately determine the ‘lifetime’ of the oscillation of an ion from its STORI plot. This is important because, given the shape of the ‘lines’ on a STORI plot, their slope will depend on which part of the ‘line’ one uses to estimate the value of that slope. As an illustration, in the present simulations we ‘know’ the lifetime of Ion #1, Ion #2 and Ion #3 (i.e. 1000 ms, 200 ms and 300 ms respectively), however when determining a notional linear ‘gradient’ for each curve, via a linear regression analysis of their respective STORI curves (2, 3 and 4), the result is the following charges for these ions (in units of the electron charge, e):

| | |
|---|---|
| Ion#1 | 49.6 |
| Ion#2 | 28.4 |
| Ion#3 | 34.4 |

The true charge is 50e. This STORI result is hardly acceptable. Even the estimate of the charge of Ion #1, which has an oscillation ‘lifetime’ spanning its entire STORI plot, is poor due to the periodic noise present in curve 2 due in part to the influence from the other ion signals (Ion #2, Ion #3) of oscillation frequency close to that of Ion #1. Thus, it is important to reduce the charge measurement error contribution from the electronic noise and other noise and to minimise, or take account of, the influence from the other ion signals of nearby frequency.

The present invention has been devised in light of the above considerations.

### SUMMARY OF THE INVENTION

Image-charge/current signals may be acquired in mass spectrometers which use non-destructive detection of signals containing periodic components corresponding to oscillations of certain trapped ion species. However, the invention is applicable to any other field ion analysis where signals containing periodic components need to be analysed. The frequency of ion motion depends on its mass-to-charge (m/z) ratio, and where multiple packets of ions exist within an ion analyser (e.g. ion trap), the motion of each packet of ions with the same m/z ratio may be synchronous as provided by the focusing properties of an ion analyser.

Detection of ions using image charges is based on principles derived by Shockley [W. Shockley: “Currents to Conductors Induced by a Moving Point Charge”, Journal of Applied Physics 9, 635 (1938)] and Ramo [S. Ramo: “Currents Induced by Electron Motion”, Proceedings of the IRE, Volume 27, Issue 9, September 1939]. Here it was shown that a measurable current is induced in an electrode by the image of a moving charge passing by that electrode. The induced image charge, Q, on the electrode of a detector device produced by a charge q moving in free space with a vector of velocity (\vec{v}(r)), depends upon only the location, r, and velocity of the moving charge and the configuration of the electrodes of the detector device. The image charge Q is independent of the bias voltages applied to the electrodes, and of any space charge present, and is given by:

$$Q = - q V ( r )$$

Here V(r) is the potential of the electrostatic field at the location of the charge given by vector r within the detector apparatus. The induced image-charge/current, I, is given by the rate of change of this quantity as follows:

$$I = \frac{d Q}{dt} = - q \frac{d V ( r )}{dt} = - q \frac{d V ( r )}{d r} \cdot \frac{d r}{dt} = q \vec{E} ( r ) \cdot \vec{v} ( r )$$

Here \vec{E}(r) is an electric field (vector) known as the “weighting field”. As a simple and illustrative example of how this relationship may be implemented, consider a detector apparatus comprising a pair of plane parallel electrode plates separated by a uniform distance d, between which an ion of charge q moves at speed v₀ in a circular orbit in a plane which is perpendicular to the plane of the two electrode plates. The “weighting field” is uniform and directed perpendicular to the electrode plates and parallel to the ion orbit (practically speaking, this is effectively true if the dimensions of the plates are much larger that the distance between them, so that the fringe effects are negligible). Thus:

$$\vec{E} ( r ) \cdot \vec{v} ( r ) = \frac{{v}_{0}}{d} cos ( ω t + φ )$$

As a result, the induced image-charge/current is a sinusoidal oscillatory signal of the form:

$$I = q \frac{{v}_{0}}{d} cos ( ω t + φ )$$

The amplitude of the induced image-charge/current is proportional to the charge, q, of the ion. By measuring this amplitude, one may determine the charge on the ion, once the constant of proportionality term v₀/d is taken into account. More generally, the same principle applies to more complex electrode structures of a detector apparatus, in that the amplitude of the induced image-charge/current is proportional to the charge, q, of the ion, and the constant of proportionality term will differ depending upon the geometry of the electrodes of the detector apparatus.

The invention relates to analysis of image-charge/current signals. A signal may contain one or more periodic components. Periodicity of a component implies that it reveals changes in magnitude or amplitude of the signal occurring once with a certain period of time, and repeating once each successive such period of time. Each periodic component is also called a frequency component of the signal. The total signal is the sum of all periodic/frequency components. The period, T (seconds), of a periodic component corresponds to a frequency, f (Hz), of the corresponding frequency component via the relation: f=1/T. Herein, we refer to “periodic component” and “frequency component” interchangeably in this sense. An image-charge/current signal may be non-harmonic or harmonic in nature, and both instances may comprise periodic components within them. For example, the image charge/current signal may result from ion motion that is “simple harmonic motion”, such that the image charge/current signal may be sinusoidal in form. However, the invention is not limited to such signals and such ion motion. Accordingly, an image charge/current signal may result from other types of harmonic motion of ions, which is not “simple harmonic motion” but is a repeating periodical motion. The invention is particularly, although not exclusively, relevant to ion traps where ion motion is periodic or nearly periodic and is detected by pick-up (image-charge/current) detectors.

At its most general, the invention provides methods and apparatus for determining the charge on a target ion by processing a time-domain image-charge/current signal corresponding to one or more ions undergoing oscillatory motion within an ion analyser apparatus, in which the determination of charge is based on a selected one or more of the frequency-domain harmonic components of a previously obtained time-domain image-charge/current signal which have been corrected or processed to remove spectral interferences from spectral components of the oscillatory motion of ions other than a target ion that contribute to the time-domain image-charge/current signal. An advantage of the invention is to account for the spectral leakage of a non-target ion's spectral energy into adjacent frequency bins of the frequency spectrum of the obtained time-domain image-charge/current signal of the ion. The invention may comprise determining a magnitude or amplitude of a harmonic component of the frequency-domain transform of the image-charge/current signal and therewith calculating a value representative of the charge of the target ion undergoing oscillatory motion within the ion analyser apparatus.

Spectral energy from other ions may ‘leak’ into this bin(s) and the present invention may provide means to estimate those contributions from ‘leakage’ from adjacent spectral bins associated with other ions (i.e. not associated with the target ion). In this way, the invention may account for the influence of the image-charge signal of other ions (i.e. other than the target ion) that may coexist within the trap at the time the image-charge/current signal of the ion was obtained. The invention also has the advantage that it may reduce the influence of noise when analysing the obtained time-domain image-charge/current signal of the ion. Overall, these benefits improve the accuracy of the evaluation of a target ion's charge, amongst other things.

In some embodiments, determining the charge on a target ion is based on a selected one or more of the frequency-domain harmonic components of a selected sub-portion/time-interval of a previously obtained time-domain image-charge/current signal. The size or duration of the selected signal sub-portion/time-interval is preferably selected in proportion to (e.g. as a multiple of) the value/size of the period of oscillatory motion of target ions within the ion analyser apparatus. The appropriate selection of the sub-portion/time-interval has been found to improve the clarity of the frequency-domain spectrum of an image-charge/current signal and thereby improve its efficacy for use in calculating a value representative of the charge of an ion undergoing oscillatory motion within the ion analyser apparatus. An advantage of the invention, in some embodiments, is to reduce the spectral leakage of the target ion's spectral energy into adjacent frequency bins of the frequency spectrum of the obtained time-domain image-charge/current signal of the ion. Advantageously, a greater proportion of the spectral energy of the frequency spectrum associated with the target ion may be concentrated within fewer spectral frequency bins, or just one spectral frequency bin.

In a first aspect, the invention may provide a method of processing an image-charge/current signal representative of one or more ions undergoing oscillatory motion within an ion analyser apparatus, the method comprising:
obtaining a recording of the image-charge/current signal generated by the ion analyser apparatus in the time domain;
   by a signal processing unit:
applying a transform of the recorded signal to provide a frequency-domain signal;
selecting N (where N is an integer>1) separate values (OPₙ, where n=1 to N; N≥M) of the frequency-domain signal each from amongst a plurality of separate adjacent signal peaks of the frequency-domain signal which include a signal peak corresponding to a target ion; and,
solving a system of equations:

$${OP}_{n} = {\sum }_{m = 1}^{M} {α}_{n m} \times {TP}_{m} ,$$

$$for n = 1 to N ;$$

$$N \geq M$$

where αₙₘ are coefficients and TPₘ are corrected values of M of the selected N separate values of the frequency-domain signal;
selecting the corrected value (TPₘ) from amongst the M corrected values of the frequency-domain signal corresponding to a signal peak (e.g. a harmonic peak) associated with the target ion;
calculating a value representative of the charge of said target ion undergoing oscillatory motion within the ion analyser apparatus based on the selected corrected value (TPₘ). This system (matrix) of equations may be used to find the ‘best’ set of solutions of the corrected values (TPₘ) via e.g. a least squares numerical solution (or other method of solution available to the skilled person) to the matrix equation:

$$\vec{TP} = {[ α ]}^{- 1} \cdot \vec{OP}$$

Here, [symbol] =[TP₁, TP₂, . . . , TP_{M}]^{T} and [symbol] =[OP₁, OP₂, . . . , OP_{N}]^{T}. The matrix [α] is the n×m matrix of elements αₙₘ residing in its n^{th} row and m^{th} column.

Preferably, the value of N is greater than the value of M in this matrix equation. In this way, by having more equations than unknowns, it has been found that the solution to the matrix equation is more stable.

For example, within any signal ‘peak’ one may select more than one signal value (i.e. multiple separate values from within the same given ‘peak’ structure). This will result in more signal values than there are signal ‘peak’ structures, or ions to produce those ‘peak’ structures. As an example, consider a spectrum displaying two adjacent ‘peaks’ in a spectrum. It is possible to select two separate signal values (OP₁ and OP₂) from different locations within the same one of these two peaks, and to select a third signal value (OP₃) from within the second ‘peak’ structure.

This would mean that, instead of building the system of equations as a 3×3 matrix follows:

$${OP}_{1} = {α}_{11} {TP}_{1} + {α}_{12} {TP}_{2} + {α}_{13} {TP}_{3}$$

$${OP}_{2} = {α}_{21} {TP}_{1} + {α}_{22} {TP}_{2} + {α}_{23} {TP}_{3}$$

$${OP}_{3} = {α}_{31} {TP}_{1} + {α}_{32} {TP}_{2} + {α}_{33} {TP}_{3}$$

The invention permits one to build the equations as follows, in which OP₁ and OP₂ are created by one ion, and OP₃ is created by another ion:

$${OP}_{1} = {α}_{11} {TP}_{1} + {α}_{12} {TP}_{2}$$

$${OP}_{2} = {α}_{21} {TP}_{1} + {α}_{22} {TP}_{2}$$

$${OP}_{3} = {α}_{31} {TP}_{1} + {α}_{32} {TP}_{2}$$

Here the system of equations has more equations than unknowns (i.e. a 3×2 matrix) and the inventors have found that one may achieve a stable solution to the matrix equation. This is indicative of the matrix of equations containing more relevant information about the signal which improves the accuracy of their solution. Preferably, from within multiple signal ‘peaks’ (e.g. for each signal ‘peak’ structure) one may select more than one signal value (i.e. multiple separate signal values from within the same given ‘peak’ structure, for each one of multiple ‘peak’ structures).

For a further example, a situation can arise in which there exist more signal ‘peaks’ than there are ions to produce them. As an example, consider a spectrum displaying three adjacent ‘peaks’ in a spectrum, but in which only two ions (ion #1 and ion #2) exist in the device. It is possible that a first peak (OP₁) is produced by ion #1, and a second peak (OP₂) is produced by ion #2, but an apparent third peak (OP₃) is produced merely by a superposition of a side-lobe from peak OP₁ and a side-lobe from peak OP₂. It can be ‘mistaken’ for being a peak due to a non-existent ion #3.

This would mean that, instead of building the system of equations as a 3×3 matrix follows:

$${OP}_{1} = {α}_{11} {TP}_{1} + {α}_{12} {TP}_{2} + {α}_{13} {TP}_{3}$$

$${OP}_{2} = {α}_{21} {TP}_{1} + {α}_{22} {TP}_{2} + {α}_{23} {TP}_{3}$$

$${OP}_{3} = {α}_{31} {TP}_{1} + {α}_{32} {TP}_{2} + {α}_{33} {TP}_{3}$$

The invention permits one to build the equations as follows, in which OP₃ is purely created by ion #1 and ion #2:

$${OP}_{1} = {α}_{11} {TP}_{1} + {α}_{12} {TP}_{2}$$

$${OP}_{2} = {α}_{21} {TP}_{1} + {α}_{22} {TP}_{2}$$

$${OP}_{3} = {α}_{31} {TP}_{1} + {α}_{32} {TP}_{2}$$

Here the system of equations has more equations than unknowns (i.e. a 3×2 matrix) and the inventors have found that one may achieve a stable solution to the matrix equation. This is indicative of the matrix of equations being more representative of reality than the 3×3 matrix.

For example, one may make several selections/points (OPₙ) out of the same signal peak, and one may do this for any number of the two or more peaks that may exist in the signal spectrum, but most preferably selections/points (OPₙ) are taken from more than one peak in the spectrum.

Desirably, at least one of the selected N separate values of the frequency-domain signal corresponds to a respective adjacent signal peak which resides at a frequency that is not a harmonic frequency of target ion. For example, at least one of the selected N separate values of the frequency-domain signal corresponds to e.g. a spectral peak residing at a frequency that is a harmonic frequency of a non-target ion that potentially spectrally interferes with the spectral peak of the target ion. This may occur due to a partial overlap between the spectral peak of the target ion and parts (e.g. side lobes etc.) of the frequency-domain signal component associated with the adjacent spectral peak of the non-target ion. In this way, the selected N separate values of the frequency-domain signal most preferably include values associates with adjacent spectral peaks likely (e.g. most likely) to interfere (e.g. spectrally leak) with the spectral peak of the target ion.

Preferably, at least one of, or a plurality of, the selected N separate values of the frequency-domain signal corresponds to a respective adjacent signal peak which resides at a frequency that is not a harmonic frequency of the target ion (i.e. the ion we wish to determine the charge of). For example, OP₁ may a value of the frequency-domain signal corresponding to a frequency which is a harmonic of the motion of the target ion (e.g. the value ‘observed’ to be the highest value within the signal ‘peak’ shape corresponding to a harmonic—‘OP’ denoting ‘Observed Peak’). For example, OPₙ (where n>1) may be values of the frequency-domain signal corresponding respectively to a frequency which is a harmonic of the motion of another respective ion that is not the target ion (e.g. the value ‘observed’ to be the highest value within the signal ‘peak’ shape corresponding to a harmonic—‘OP’ denoting ‘Observed Peak’). In this way, a set of equations is provided which represents the contributions (αₙₘ) made to each one of the selected separate values (OPₙ) of the frequency-domain signal, by the motion of all ions contributing to the signal associated with a given harmonic of the target ion. By solving this set of equations, one may obtain a corrected value (TP₁) of the frequency-domain signal associated with a given harmonic of the target ion (e.g. the value corrected to be what is assumed to be the ‘true’ value for the ‘peak’ shape generated by the target ion—‘TP’ denoting ‘True Peak’), in which the contribution from the motion of the all other ions contributing to the signal is removed. One may also obtain a corrected value TPₘ (where m>1) of the frequency-domain signal associated with a given harmonic of the non-target ion(s), in which the contribution from the motion of all other ions (including that of the target ion) contributing to the signal is removed.

As an example, in the case where three (or more . . . ) separate values of the frequency-domain signal are selected, each corresponding to a respective one of three (N=3) adjacent signal peaks which each resides at a respective frequency that is a harmonic frequency of an ion contributing to the overall signal (i.e. the target ion and two other non-target ions), then the above equation may be expressed as:

$$\begin{matrix}{OP}_{1} & = & {α}_{11} {TP}_{1} & + & {α}_{12} {TP}_{2} & + & {α}_{13} {TP}_{3} & + & ⋯ \\ {OP}_{2} & = & {α}_{21} {TP}_{1} & + & {α}_{22} {TP}_{2} & + & {α}_{23} {TP}_{3} & + & ⋯ \\ {OP}_{3} & = & {α}_{31} {TP}_{1} & + & {α}_{32} {TP}_{2} & + & {α}_{33} {TP}_{3} & + & ⋯ \\ ⋮ & & ⋮ & & ⋮ & & ⋮ & & \end{matrix}$$

$$Here ,$$

$${α}_{n m} = {e}^{\frac{i ( {ω}_{m} - {ω}_{n} ) {T}_{E}}{2}} * \frac{sin \frac{( {ω}_{m} - {ω}_{n} ) {T}_{E}}{2}}{{ω}_{m} - {ω}_{n}}$$

Where m refers to an ion oscillation at frequency ωₘ associated with an adjacent peak TPₘ, n refers to the frequency ωₙ of the component we are interested in. The term T_{E} denotes a time at which the recorded image-charge/current signal comes to the end of its life (i.e. ceases).

Solving this set of simultaneous equation for: TP₁, TP₂, TP₃, provides a corrected value (e.g. TP₁, for the target ion) to be used in the step of calculating the charge of the target ion, as described above, based on a selected frequency-domain ‘True Peak’ for the target ion.

The frequency-domain signal may be derived from a frequency-domain transform (e.g. a Fourier transform) applied to the time-domain signal, in which the transformed signal is represented by complex numbers. A complex number possesses a magnitude and a phase as expressed in the complex (Argand) plane. A complex number has a real component and an imaginary component. The magnitude is given by the sum of: the square of the real component, and the square of the imaginary component. The phase is given by the arctangent of the ratio of:the real component, and the imaginary component.

The values of the frequency-domain signal to be used in the step of calculating the ion charge may be complex numbers representing the transformed signal. For example, the selected N separate values (OPₙ) of the frequency-domain signal may each be a complex number. For example, the corrected M separate values (TPₘ) of the frequency-domain signal may each be a complex number. The coefficients (αₙₘ) may be complex numbers. By taking the phases of these complex coefficients into account, the corrected M separate values (TPₘ) of the frequency-domain signal may be more accurate. After the solutions TP are found (complex numbers) one may calculate the magnitudes of these complex numbers determined by calculating: Magnitude=sqrt({Re[TP]}²+{Im[TP]}²)). This calculation may be done for several points for each harmonic of each peak. With the determined magnitude of the target peak to hand, the charge of the associated ion may be calculated.

Preferably, before said step of applying a transform of the recorded signal to provide a frequency-domain signal, the method includes:
determining a value for the period of a periodic signal component within the recorded signal;
truncating the recorded signal to provide a truncated signal having a duration substantially equal to an integer multiple of said period; and subsequently,
performing the step of applying a transform of the recorded signal in which the recorded signal is the truncated signal, to provide the frequency-domain signal; whereby,
the step of calculating a value representative of the charge of a target ion is based on a corrected value (TPₘ) of the frequency-domain signal corresponding to the truncated signal.

In this way, the invention may include determining a frequency (or period) of ion oscillation from a recorded image-charge/current signal. The method may include determining the lifetime of this oscillation within the signal. The invention may provide a truncation to the recorded signal, with the requirement that the truncated signal length is substantially an integer multiple of an oscillation period (T=1/f) of the recorded oscillatory signal. This has the consequence of increasing the signal-to-noise (S/N) ratio in the reconstructed time-domain signal, as discussed below. The invention may include truncating the length of the recorded image charge signal (in the time domain) to be within the lifetime of the oscillation. Accordingly, most preferably, the duration of the truncated signal does not exceed, or does not greatly exceed, the lifetime of the periodic signal component within the recorded signal.

The truncation of the recorded signal may be done so that, for example, the terminal end of the truncated signal coincides with a time just before or just after the end of the lifetime of the periodic signal component within the recorded signal (i.e. the ion oscillatory motion). Put in other words, the periodic signal components may present a succession of many signal peaks arranged periodically in time (i.e. spaced in time by the period T) throughout the duration of the lifetime of the ion oscillatory motion that produced them. The lifetime of this oscillatory motion may be considered to have ended when the amplitude of such signal peaks falls below a threshold amplitude value. For example, the lifetime of the ion oscillatory motion, and of the oscillatory signal component it produces, may be considered to have ended when the amplitude of the signal peak of that component deviates (falls) by more than about 20% from the value of the largest peak value (e.g. magnitude) of the component within the recorded signal. Preferably this deviation is more than about 15%, or is more than about 10%, or is more than about 5%, from the value of the largest peak value (e.g. magnitude). The truncation of the recorded signal may be implemented such that the truncated signal includes only those signal peaks of the signal component that have an amplitude greater than the threshold amplitude value. This means, in effect, that the ion oscillatory motion was ‘alive’ during the whole of the truncated signal (i.e. its lifetime had not ended). For example, if the recorded signal S(t) contains a periodic component has a period of T seconds and a lifetime of T_{LT} seconds, then the duration of the truncated signal may be N×T, where N×T<T_{LT}, and N is an integer.

Alternatively, the truncation of the recorded signal may be implemented such that the truncated signal includes those signal peaks of the signal component that have an amplitude greater than the threshold amplitude value, plus one (or two) signal peaks immediately following the end of the ‘lifetime’ of the ion oscillatory motion that have an amplitude less than the threshold amplitude value. This truncation may be acceptable if the ion oscillatory motion initially begins to ‘die’ relatively slowly, and the aforementioned fall in the amplitudes of successive signal peaks is relatively slow such that the ‘time of death’ falls in between e.g. the final two successive signal peaks of the truncated signal. For example, if the recorded signal S(t) contains a periodic component has a period of T seconds and a lifetime of T_{LT} seconds, then the duration of the truncated signal may be (N+1)×T where: N×T<T_{LT}<(N+1)×T and N is an integer.

The step of truncating the recorded image-charge/current signal provides an appropriate selection of the sub-portion/time-interval such that the length of the truncated signal is an integer multiple of the period of the ion oscillation, this period being determined according to the frequency of ion oscillation. The truncation may provide a sub-portion/time-interval of the recorded image-charge/current signal which starts substantially at the recorded start time of the recorded image-charge/current signal and ends at a recorded time before the recorded end time of the recorded image-charge/current signal. This arrangement may be appropriate in cases where the one or more ions are injected into the ion analyser apparatus from an ion trap or ion guide such that they may undergo oscillatory motion immediately upon entering the ion analyser apparatus. The invention may comprise an apparatus including ion analyser apparatus as described herein, and an ion trap or ion guide configured to inject ions into the ion analyser apparatus for this purpose. Alternatively, the truncation may provide a sub-portion/time-interval of the recorded image-charge/current signal which starts at a recorded time after the recorded start time of the recorded image-charge/current signal and ends at a recorded time before the recorded end time of the recorded image-charge/current signal. This alternative may be appropriate where the one or more ions are created within the ion analyser apparatus (e.g. by collision with another ion, atom or molecule) such that they undergo oscillatory motion only after recording of the image-charge/current signal has started.

Preferably, the truncation selects a sub-portion/time-interval of the recorded image-charge/current signal within which a sequence of repeating signal peaks reside which each have substantially the same peak signal value as each other, or which each have a respective peak signal value which deviates by not more than about 20% from the value of the largest peak value (e.g. magnitude). Preferably this deviation is not more than about 15%, or is not more than about 10%, or is not more than about 5%, from the value of the largest peak value (e.g. magnitude).

In this way, an appropriate selection of the sub-portion/time-interval may be such that the truncated signal comprises predominantly, or substantially fully, a part of the recorded image-charge/current signal corresponding to a ‘steady’ ion oscillation signal. Put another way, the recorded image-charge/current signal will contain a sub-portion/time-interval in which ‘strong’ and ‘steady’ repeating signal peaks reside which have substantially the same amplitude (and often substantially the same shape/structure) which indicate a steady ion oscillation. However, the recorded image-charge/current signal will also contain one or more other sub-portions/time-intervals, sometimes around the beginning and certainly around the end of the recorded image-charge/current signal, in which successive signal peaks of differing amplitude and shape reside—often of varying (e.g. falling) amplitude and varying (e.g. increasing) width. These indicate an unsteady ion oscillation and are not appropriate for use in an accurate calculation of a value representative of the charge of the ion undergoing oscillatory motion within the ion analyser apparatus. The invention may avoid them when appropriate selection of the sub-portion/time-interval is made for providing the truncated signal.

The step of truncating the recorded signal may comprise:
transforming the recorded time-domain signal into a frequency-domain (e.g. by a Fourier transform) thereby to generate a transformed recorded signal;
selecting a peak value of the transformed recorded signal from within a signal peak of the transformed recorded signal corresponding to a frequency-domain harmonic component of the recorded signal;
selecting a first adjacent value of the transformed recorded signal within the signal peak and corresponding to a frequency less than the frequency associated with the peak value;
selecting a second adjacent value of the transformed recorded signal within the signal peak and corresponding to a frequency greater than the frequency associated with the peak value;
reconstructing a time-domain signal based on the selected peak value, the selected first adjacent value and the selected second adjacent value;
determining a threshold time at which an amplitude modulation within the reconstructing a time-domain signal falls below a threshold signal value;
truncating the recorded signal according to the threshold time so determined.

The threshold signal value may be a signal value corresponding at least about 80% of the largest value (e.g. amplitude of the modulation envelope) of the amplitude modulation. Preferably the threshold signal value is at least about 85%, or is at least about 90%, or is at least about 95%, of the largest value (e.g. amplitude of the modulation envelope) of the amplitude modulation. The user may determine an appropriate threshold signal value empirically within these limits.

The frequency (ω_{Peak}) associated with the selected peak value is preferably selected to be as close as possible to the frequency of the harmonic associated with the given signal peak of the transformed recorded signal (i.e. ω_{Peak}=ω_{N}=Nω₁, where ω₁ is the fundamental frequency [first harmonic], N is an integer). It may be selected simply by selecting the largest value of the signal within the given signal peak of the transformed recorded signal, as this tends to reside at frequency of the harmonic in question. It has been found that the third harmonic of the frequency-domain harmonic components of the recorded signal can be particularly suitable for use as the harmonic from which to obtain the selected peak value, the selected first adjacent value and the selected second adjacent value. However, frequency-domain signal peaks that correspond with harmonics other than the third harmonic may be used if found empirically to be more suitable, as this can depend on the shape of the time domain signal which in turn can depend on the geometry of the ion analyser instrument. In addition, it has been found that the signal-to-noise ratio (S/N) of frequency-domain peaks of increasingly higher harmonics tends to be increasingly worse (i.e. falls). Ultimately, a practical and appropriate choice may be made by the user balancing these cost/benefit factors. It has been found that the third harmonic (or other, e.g. neighbouring, harmonic depending on circumstances) has the combined advantages of having a good strength, having a narrow spectral profile shape, being relatively free of interference from other harmonic components, and also corresponding to a frequency (ω₃=3ω₁, where ω₁ is the fundamental frequency [first harmonic]) which results in a suitable rate of variation/slope/fall in the shape of the amplitude modulation within the reconstructing a time-domain signal for use in providing an threshold in the signal truncation process.

The first adjacent value is preferably selected to correspond to a frequency (ω_{FA}) that is lower than the frequency (ω_{Peak}) of the selected peak value (i.e. ω_{FA}=ω_{Peak}−Δω_{FA}, where Δω_{FA} is a frequency difference) by an amount (Δω_{FA}) not exceeding half of the full-width-at-half-maximum (FWHM) of the given signal peak of the transformed recorded signal. The second adjacent value is preferably selected to correspond to a frequency (ω_{SA}) that is higher than the frequency (ω_{Peak}) of the selected peak value (i.e. ω_{SA}=ω_{Peak}+Δω_{SA}, where Δω_{SA} is a frequency difference) by an amount (Δω_{SA}) not exceeding half of the full-width-at-half-maximum (FWHM) of the given signal peak of the transformed recorded signal. This assumes, of course, that the given signal peak of the transformed recorded signal can be resolved into a peak structure with a discernible width within the frequency resolution (bin size) of the frequency-domain representation being used.

$$Preferably , {Δω}_{FA} = {Δω}_{SA} .$$

If desired, an optional step of reconstructing a time-domain signal may be based on a selected one or more frequency-domain harmonic components of the truncated signal, and may comprise calculating a time-domain signal using an inverse transform (e.g. inverse Fourier transform) of the frequency-domain transform applied to the truncated time domain signal to generate the aforesaid frequency-domain harmonic components of the truncated signal. For example, the method may include calculating a Fourier transform of the truncated time domain signal to generate the aforesaid frequency-domain harmonic components of the truncated signal and subsequently applying an inverse Fourier transform in reconstructing a time-domain signal based on a selected one or more frequency-domain harmonic components of the truncated signal.

For example, optionally if desired, the method may include calculating a Fourier transform of the truncated time domain signal, and selecting at least one value (e.g. a single point) of the transformed truncated time domain signal residing at each one of a plurality of (e.g. each of) the harmonic peaks therein. The invention may include reconstructing the time-domain signal (i.e. representing a ‘cleaned’ version of the image-charge signal) using the selected value(s) of the transformed truncated time-domain signal. By the appropriate selection of the sub-portion/time-interval for providing the truncated signal, as described above, the invention may thus provide a ‘cleaner’ time domain signal comprising harmonics (e.g. in the Fourier spectrum) that are more representative of the ion undergoing oscillatory motion, and are relatively less contaminated by other harmonic components arising from the presence and interference of other ions within the ion analyser apparatus, and relatively less degraded by noise (i.e. a greater signal-to-noise ratio).

The ion analyser apparatus may be configured for producing ions. The ion analysis chamber may be configured for trapping the ions such that the trapped ions undergo oscillatory motion, and obtaining a plurality of image charge/current signals representative of the trapped ions undergoing oscillatory motion using at least one image charge/current detector.

The ion analysis chamber may comprise any one or more of: an ion cyclotron resonance trap; an Orbitrap® configured to use a hyper-logarithmic electric field for ion trapping; an electrostatic linear ion trap (ELIT); a quadrupole ion trap; an ion mobility analyser; a charge detection mass spectrometer (CDMS); Electrostatic Ion Beam Trap (EIBT); Orbital Frequency Analyser (OFA), a Planar Electrostatic Ion Trap (PEIT), for generating said oscillatory motion therein.

In another aspect, the invention may provide a computer-readable medium having computer-executable instructions configured to cause a mass spectrometry apparatus to perform a method of processing a plurality of image charge/current signals representative of trapped ions undergoing oscillatory motion, the method being as described above. The signal processing unit may comprise a processor or computer programmed or programmable (e.g. comprising a computer-readable medium containing a computer program) to implement the configured to execute the computer-executable instructions.

Herein, the term “peak”, as a noun, may be taken to include a reference to a projecting pointed part or shape or structure (e.g. within a signal), or a highest region, point, value or level (e.g. within a signal).

Herein, the term “recording”, as a verb, may be taken to include a reference to making a contemporaneous record of a signal as the signal is generated, and may be taken to include a reference to recording data representing a signal, e.g. by recording/making a copy of pre-recorded such data, or obtaining such a recording. The term “recording”, as a noun, may be taken to include a reference to the result of the act of “recording”.

Herein, the term “time domain” may be considered to include a reference to time considered as an independent variable in the analysis or measurement of time-dependent phenomena. Herein, the term “frequency domain” may be considered to include a reference to frequency considered as an independent variable in the analysis or measurement of time-dependent phenomena.

The term “periodic” used herein may be considered to include a reference to a phenomenon (e.g. a signal transient, or peak, or pulse) appearing or occurring at intervals. The term “period” includes a reference to the interval of time between successive occurrences of the same event or state, or substantially the same event or state, in an oscillatory or cyclic phenomenon.

The term “segmenting”, as a gerund of a verb, may be taken to include a reference to dividing something into separate parts or sections. The term “segment”, as a noun, may include a reference to each of the parts into which something is or may be divided.

The term “co-registering”, as a gerund of a verb, may be considered to include a reference to the process of aligning two or more items together within the domain (e.g. time domain) in which both items are represented or defined. The process may involve designating one item as the reference item and applying geometric transformations, coordinate transformations or local displacements, or numerical/mathematical constraints within the domain, to the other item so that it aligns with the reference item.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1a shows the theoretical form of a STORI plots according to the prior art;

FIG. 1b shows several STORI plots according to a simulation;

FIG. 2a shows an ion analyser apparatus according to an embodiment of the invention;

FIG. 2b shows an image-charge/current signal generated by an ion analyser apparatus comprising a plurality of pulses within the image-charge/current signal forming a periodic succession of repetitive signal pulses, with repetition period T;

FIG. 2c shows a schematic representation of a 2D function comprising a stack of segmented portions of an image-charge/current signal representative of oscillatory motion of one or more ions in an ion analyser apparatus;

FIG. 2d shows a schematic representation of an image-charge/current signal such as shown in FIG. 2c, in which a process of segmentation is being applied;

FIGS. 2e and 2f show an image-charge/current signal generated by an ion analyser apparatus corresponding to FIG. 2a, comprising a plurality portions of duration T (seconds) of the same one image-charge/current signal that contains a periodic succession of repetitive signal pulses, with repetition period T. Each of the portions is overlaid upon each other, so as to be co-registered with each other upon the same time axis section (t=0 to t=T), in the view of FIG. 2b. Each of the portions is stacked along a dimension perpendicular to the time axis in alignment so as to be co-registered with each other in the view of FIG. 2c;

FIG. 3 shows a frequency spectrum of a recorded image-charge/current signal that contains a succession of spectral peaks located at frequency harmonics;

FIG. 4 shows an image-charge/current signal reconstructed using three values selected from within the third harmonic (H3) peak in the frequency spectrum of FIG. 3, and from the reconstructed signal an estimate of the lifetime of the ion responsible for the original signal;

FIG. 5 shows an image-charge/current signal to be truncated based on an estimate of the lifetime of the ion shown in FIG. 4;

FIG. 6 shows a frequency spectrum of a truncated recorded image-charge/current signal that has been truncated as indicated in FIG. 5 and which contains a succession of spectral peaks located at frequency harmonics;

FIG. 7 shows an image-charge/current signal reconstructed using values selected from within multiple spectral peaks located at frequency harmonics (H1′, H2′, H3′) in the frequency spectrum of FIG. 6, and which contains a periodic succession of repetitive signal pulses, with repetition period T. Also shown is the original (non-reconstructed) image-charge/current signal from which the reconstructed signal derives;

FIG. 8 shows a frequency spectrum of a recorded image-charge/current signal that contains a succession of spectral peaks located at frequency harmonics (H1, . . . , Hi) generated by oscillatory motion of a target ion, and each of which is surrounded by a number of smaller adjacent harmonic spectral peaks generated by oscillatory motion of other non-target ions;

FIG. 9 shows a section of a frequency spectrum of a recorded image-charge/current signal that contains cluster of three spectral peaks located at frequency harmonics from amongst a succession (not shown) of further spectral spectral peaks generated by oscillatory motion of a target ion. The cluster contains a main (target) harmonic spectral peak peak and two smaller adjacent spectral peaks located at frequency harmonics generated by oscillatory motion of other non-target ions. Also shown is a system of three simultaneous equations associated with the three spectral peaks;

FIG. 10 shows a method according to an embodiment of the invention, which may be implemented on an ion analyser apparatus according to FIG. 2a;

FIG. 11 shows a schematic view of a recorded image-charge/current signal of full duration TR, comprised of a pure sine wave oscillatory signal of lifetime LT;

FIG. 12 shows a schematic view of frequency bins in the Fourier spectrum of the recorded image-charge/current signal both before and after its truncation;

FIG. 13 shows a schematic view of three different recorded image-charge/current signals of differing duration associated with different ions;

FIG. 14 shows a true recorded image-charge/current signal.

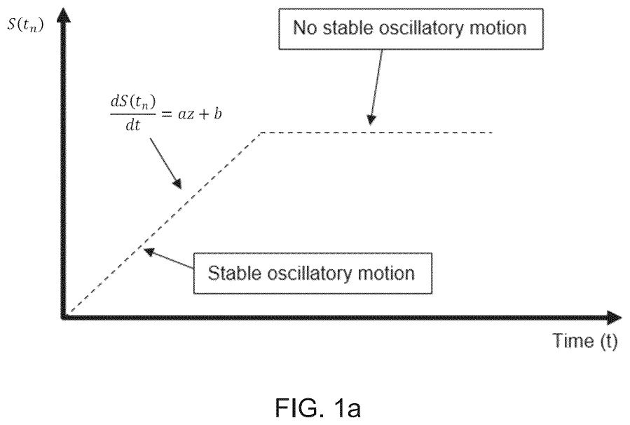

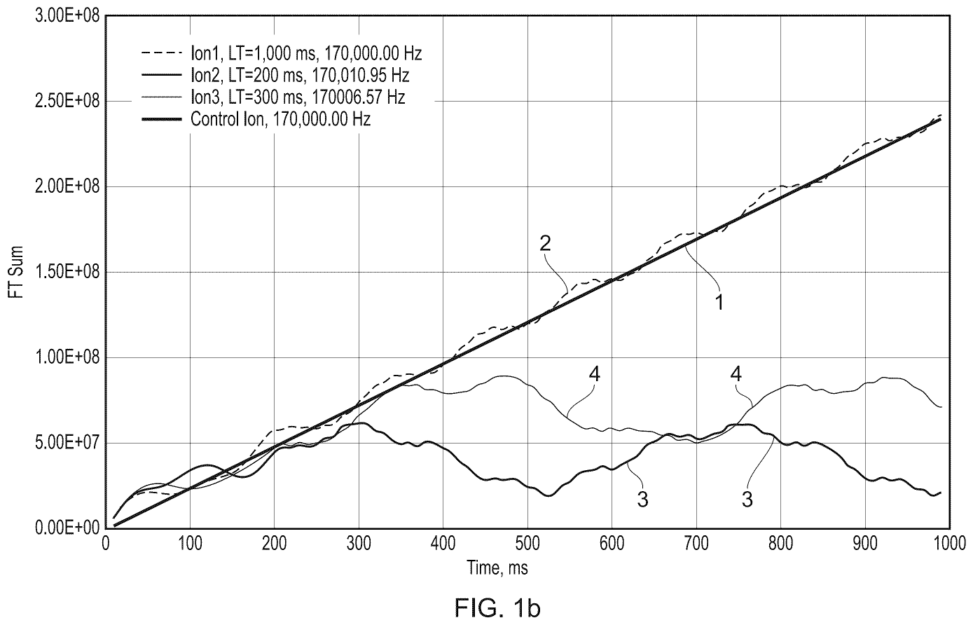

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example+/−10%.

In the drawings, like items are assigned like reference symbols, for consistency.

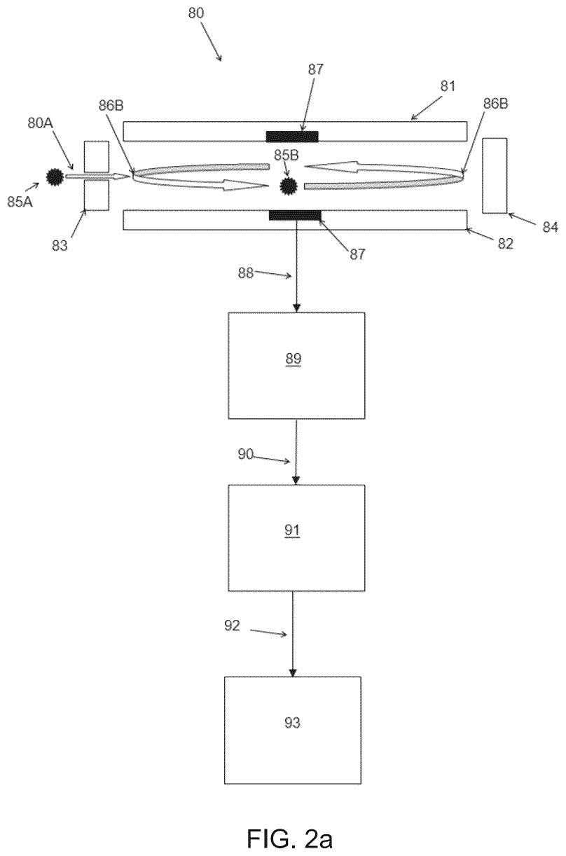

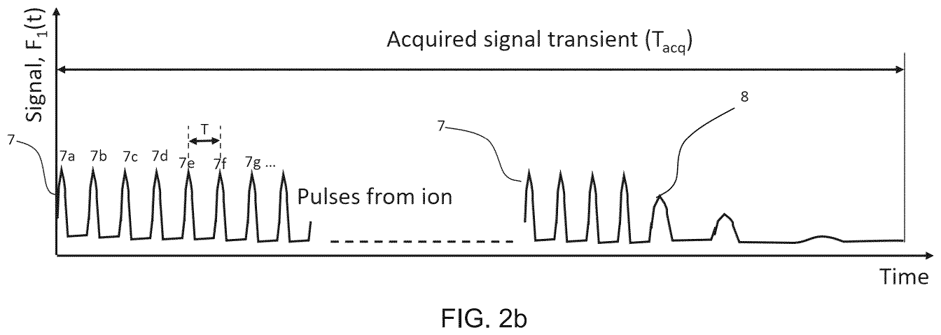

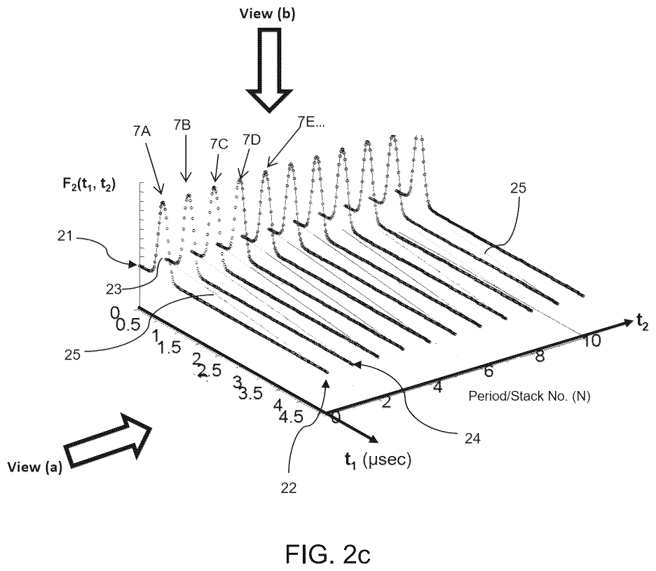

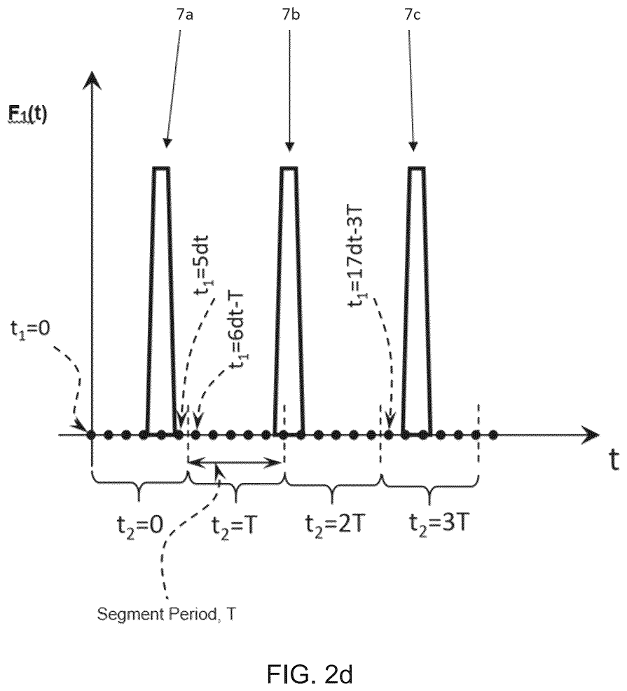

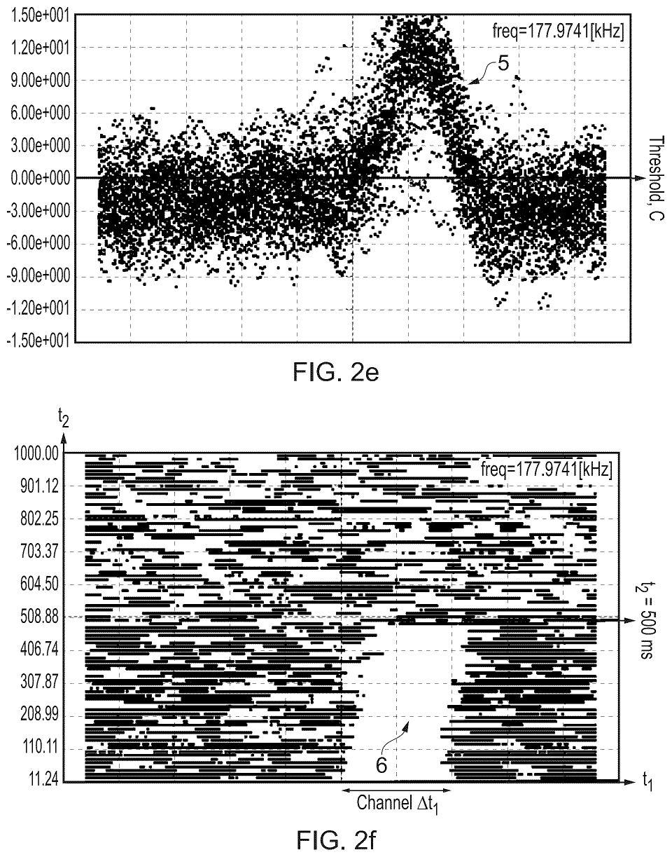

FIG. 2a shows a schematic representation of an ion analyser apparatus in the form of an electrostatic ion trap 80 for mass analysis. The electrostatic ion trap includes an ion analysis chamber (81, 82, 83, 84) configured for receiving one or more ions 85A and for generating an image charge/current signal in response to oscillatory motion 86B of the received ions 85B when within the ion analysis chamber. The ion analysis chamber comprises a first array of electrodes 81 and a second array of electrodes 82, spaced from the first array of electrodes by a substantially constant separation distance.

A voltage supply unit (not shown) is arranged to supply voltages, in use, to electrodes of the first and second arrays of electrodes to create an electrostatic field in the space between the electrode arrays. The electrodes of the first array and the electrodes of the second array are supplied, from the voltage supply unit, with substantially the same pattern of voltage, whereby the distribution of electrical potential in the space between the first and second electrode arrays (81, 82) is such as to reflect ions 85B in a flight direction 86B causing them to undergo periodic, oscillatory motion in that space. The electrostatic ion trap 80 may be configured, for example, as is described in WO2012/116765 (A1) (Ding et al.), the entirety of which is incorporated herein by reference. Other arrangements are possible, as will be readily appreciated by the skilled person.

The periodic, oscillatory motion of ions 85B within the space between the first and second arrays of electrodes may be arranged, by application of appropriate voltages to the first and second arrays of electrodes, to be focused substantially mid-way between the first and second electrode arrays for example, as is describe in WO2012/116765 (A1) (Ding et al.). Other arrangements are possible, as will be readily appreciated by the skilled person.

One or more electrodes of each of the first and second arrays of electrodes, are configured as image-charge/current sensing electrodes 87 and, as such, are connected to a signal recording unit 89 which is configured for receiving an image-charge/current signal 88 from the sensing electrodes, and for recording the received image charge/current signal in the time domain. The signal recording unit 89 may comprise amplifier circuitry as appropriate for detection of an image-charge/current having periodic/frequency components related to the mass-to-charge ratio of the ions 85B undergoing said periodic oscillatory motion 86B in the space between the first and second arrays of electrodes (81, 82).

The first and second arrays of electrodes may comprise, for example, planar arrays formed by:
(a) parallel strip electrodes; and/or,
(b) concentric, circular, or part-circular electrically conductive rings,
   as is described in WO2012/116765 (A1) (Ding et al.). Other arrangements are possible, as will be readily appreciated by the skilled person. Each array of the first and second arrays of electrodes extends in a direction of the periodic oscillatory motion 86B of the ion(s) 85B. The ion analysis chamber comprises a main part defined by the first and second arrays of electrodes and the space between them, and two end electrodes (83, 84). A voltage difference applied between the main segment and the respective end segments creates a potential barrier for reflecting ions 85B in the oscillatory motion direction 86B, thereby to trap the ions within the space between the first and second arrays of electrodes. The electrostatic ion trap may include an ion source (not shown, e.g. an ion trap) configured for temporarily storing ions 85A externally from the ion analysis chamber, and then injecting stored ions 80A into the space between the first and second arrays of electrodes, via an ion injection aperture formed in one 83 of the two end electrodes (83, 84). For example, the ion source may include a pulser (not shown) for injecting ions into the space between the first and second arrays of electrodes, as is described in WO2012/116765 (A1) (Ding et al.). Other arrangements are possible, as will be readily appreciated by the skilled person.

The ion analyser 80 further incudes a signal processing unit 91 configured for receiving a recorded image-charge/current signal 90 from the signal recording unit 89, and for processing the recorded signal to:
(a) Apply a transform of the recorded signal to provide a frequency-domain signal;
(b) Select N (where N is an integer>1) separate values (OPₙ, where n=1 to N; N≥M) of the frequency-domain signal each from amongst a plurality of separate adjacent signal peaks of the frequency-domain signal which include a signal peak (e.g. a harmonic peak) corresponding to a target ion; and, solving a system of equations:

$${OP}_{n} = {\sum }_{m = 1}^{M} {α}_{nm} \times {TP}_{m} , for n = 1 to N ; N \geq M$$

where αₙₘ are coefficients and TPₘ are corrected values of M of the selected N separate values of the frequency-domain signal;
(c) Select a corrected value (TPₘ) for the frequency-domain signal corresponding to a harmonic peak associated with the target ion;
(d) Calculate a value representative of the charge of the target ion undergoing oscillatory motion within the ion analyser apparatus based on the selected corrected value (TPₘ).

The value representative of the charge of the target ion may be, for example, the value of the selected corrected value (TPₘ) for the frequency-domain peak after multiplication by a normalisation or calibration constant or term according normalisation/calibration procedures readily apparent to the skilled person which characterise the proportionality relationship between TPₘ and the corresponding ion charge, q, in terms of the “weighting field” as described above. Often, there are ions present in the ion analyser device used to generate the image-charge/current signal, and these other ions undergo oscillatory motion at different respective oscillation frequencies and corresponding periods (Fₒₜₕₑᵣ=1/Tₒₜₕₑᵣ). These co-exist in the ion analyser and their respective oscillation frequencies may be quite close to the oscillation frequency of the target ion. These other signals present spectral peaks in the frequency spectrum of the time-domain signal that do not present as similar spectral peaks (e.g. not similar to delta functions)—they are generally smaller in amplitude and wider in width. As a result of this, the foot, base or tail of these other peaks may spread to frequencies associated with the oscillatory motion of the target ion and in so doing may interfere with the height and/or position of the sharp, tall spectral peaks associated with the target ion.

As will be described in more detail below, the present method implements steps to reduce/eliminate the interferences from the nearby peaks. By ‘nearby’, it is meant that these peaks fall into the predetermined range (ΔF, selected by the user: e.g. 0<ΔF<F₀, where F₀ is the fundamental frequency of the ion oscillation, such that the range ΔF excludes neighbouring harmonics of that oscillation) of the targeted frequency. A system of simultaneous equations for the multiple components of nearby frequencies is established and the solution to that system of equations is used to calculate the contribution from the other ions oscillating frequencies resulting in spectral components near to the targeted frequency of the target ion. These contributions are deducted from the spectrum of the signal, and the remaining targeted frequency component is used to calculate the charge of the targeted ion.

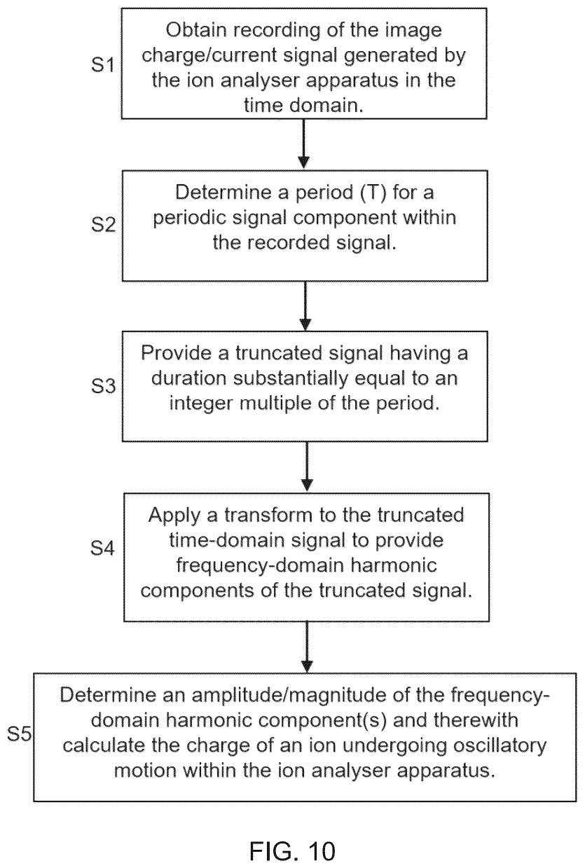

Interferences may be eliminated within the context of the more general methods of the invention illustrated with reference to FIG. 10 as follows, for example, within step (E) below:
(A) Obtain a recorded image-charge/current charge signal (FIG. 10, Step S1):
(B) Detect a set of periodic/repeating pulses in the recorded image-charge/current charge signal, and for that detected set of periodic/repeating pulses determine a period (T) for the set of periodic/repeating pulses (FIG. 10, Step S2);
(C) Determine an estimate of the lifetime of the detected set of periodic/repeating pulses;
(D) Adjust/truncate the length of the recorded image-charge/current charge signal containing the detected set of periodic/repeating pulses to be less than (and within) the determined lifetime, and so that the duration of the signal is an integer multiple of the period of the periodic/repeating pulses, and apply a frequency transform (e.g. Fourier transform) to the signal (FIG. 10, Step S3, S4);
(E) Obtain amplitudes or magnitudes of the transformed signal at the target frequency (F=1/T) and its higher harmonics; and,
   a. Find other peaks in a predetermined range near the targeted frequency and their harmonics, and determine their contribution at the targeted frequency and its harmonics;
   b. Adjust the amplitudes or magnitudes of a plurality (e.g. up to 12 or more) harmonics of the targeted frequency by deducting the contribution of the interferences from the nearby frequency peaks in accordance with solving the system of N equations described above;
(F) Use real and imaginary spectral values of one or more of those harmonics to calculate a charge value of the target ion (FIG. 10, Step S5).

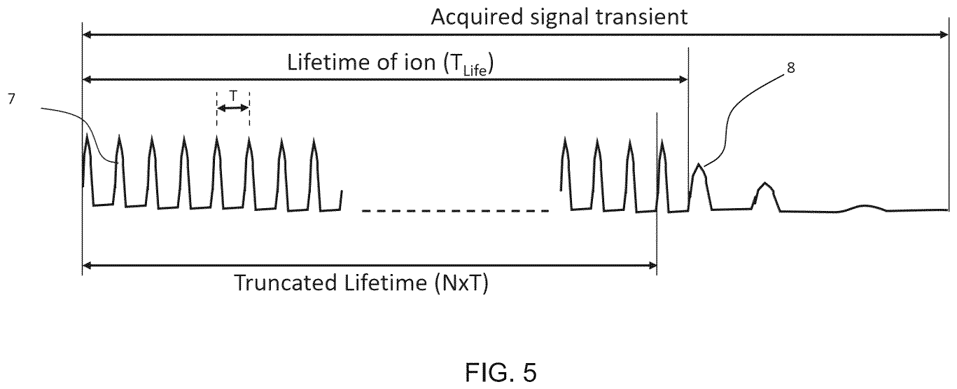

As one example of implementing step (D), above, FIGS. 2e and 2f show the experimentally acquired time-domain image-charge/current signal which was segmented by the signal period and stacked together to form a F₂(t₁, t₂) plot described in detail below with reference to FIG. 2c. By removing the points above the threshold (‘Threshold C’) the 2D plot clearly shows that the signal disappeared near t₂=500 ms (i.e. the lifetime of ion. See FIG. 5: T_{Life}). Therefore, the processing of the image-charge/current signal for this particular ion event should only focus to this lifetime (i.e. t₂<500 ms). Now with reference to FIG. 5, the method truncates the time-domain image-charge/current signal to just slightly shorter than T_{Life} so that the length of signal equals an integer multiple of the period (T) of this targeted ion motion.

For the frequency-transformed spectrum of an image-charge/current signal comprising a normal non-harmonic waveform, the number of high order harmonic spectral components (Hi) up to 12 (i.e. i=12) would be sufficient, and for a practical image-charge/current signal acquired by practical detector, and signal amplifier with limited band width, the number of order up to 5 or even 4 (i.e. i=4 to 5) would be sufficient and this can efficiently eliminate the contribution from noise and interferences. Using the ‘cleaned’ spectrum that contains only a few lines, one can, if desired, also reconstruct the time domain signal.

However, when there are other ions having similar frequencies around the targeted frequency, their frequency peaks may still influence the values at the targeted frequency, as well as its high harmonics. This is important when one wishes to run many ions in one trap cycle to increase the throughput of the measurement. When hundreds of ions fly together, it is likely that some ions fall into the frequency range that is close to the targeted frequency. The other frequency peaks cannot be represented by sharp spectral peaks (e.g. delta functions) because the signal truncation was not aligned with those other frequencies. The leakage of such nearby peaks will result in significant interferences with the targeted frequency.

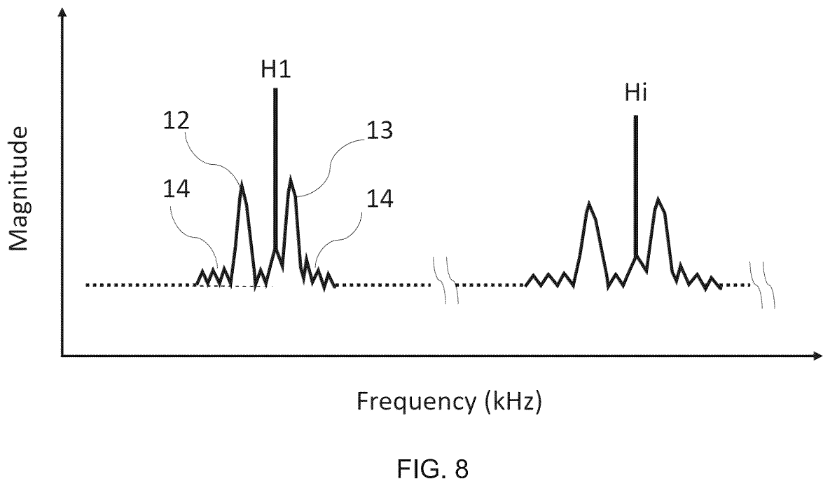

FIG. 8 shows an example of such interference, where the targeted frequency H1 and its higher harmonic Hi, both are represented by delta functions, are surrounded by two other frequencies 12, 13. These two peaks have some side lobes 14 (or frequency leakage) that will extend to the targeted frequency (H1) and to each other. It is preferable to identify such contribution from the nearby frequencies and to remove the contribution before target ion charge measurement. The present method thus includes such a correction step, as noted above, and described in detail below. In the correction step a number of interfering frequencies are identified within a predetermined frequency range, selected by the user, around the targeted frequency and their interference is removed.

In the frequency spectrum (as in FIG. 8) the observed peak value is actually the weighted combination of all components (in terms of their true peak values). Based on the known signal length used for the frequency (e.g. Fourier) transform, it has been found that a mathematical description of the distribution (weights/coefficients) for each frequency component can be derived. It has been found that a matrix of coupled equations can be constructed for sums of the contributions from all components (true peak value multiplied by a weight/coefficient) that are equal to the observed peak values. The inventors have found that a solution to this system of coupled equations gives true peak value at the targeted frequency.

By removal of the nearby frequency interferences to the targeted frequency (including interferences to the higher harmonics of the targeted frequency), reconstruction of the targeted frequency signal can be much more accurate even if there are many ions of different frequencies were flying together and their signal are co-acquired. Further filtering or smoothing of the reconstructed time domain signal may also be used before measuring its magnitude, and this can be added as general steps of signal processing as would be readily available within the common knowledge of signal processing.

In the method, the step of selecting one or more values of the frequency-domain signal comprises selecting N (where N is an integer>1) separate values (OPₙ, where n=1 to N; N≥M) of the frequency-domain signal each from amongst a plurality of separate adjacent signal peaks of the frequency-domain signal which include a signal peak corresponding to a target ion; and, solving a system of N equations:

$${OP}_{n} = {\sum }_{m = 1}^{M} {α}_{nm} \times {TP}_{m} , for n = 1 to N ; N \geq M$$

where αₙₘ are coefficients and TPₘ are corrected values of M of the selected N separate values of the frequency-domain signal. Then, the method proceeds by selecting a corrected value (TPₘ) for the value of the frequency-domain signal corresponding to a harmonic peak associated with the target ion. At least one of the selected N separate values of the frequency-domain signal corresponds to a respective adjacent signal peak which resides at a frequency that is not a harmonic frequency of target ion.

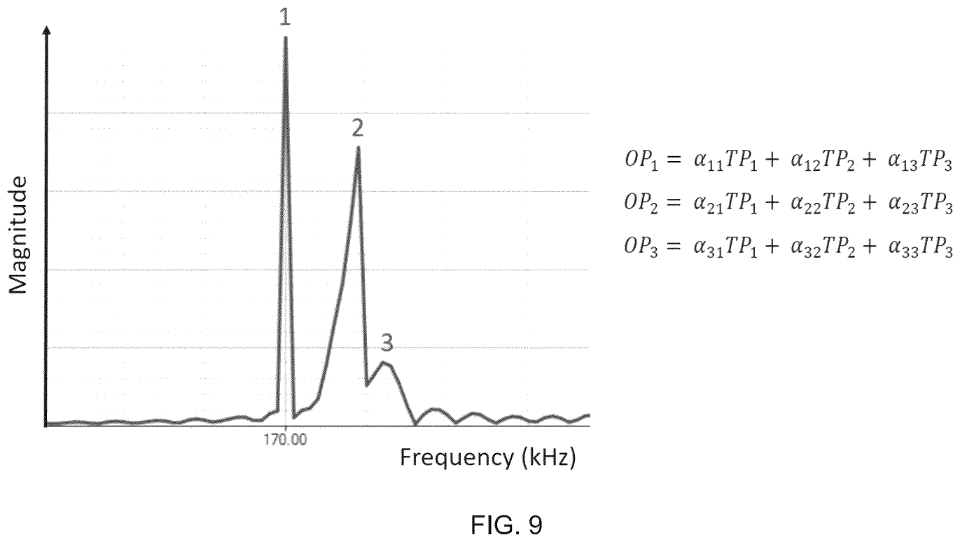

That is to say, amongst the selected N separate values of the frequency-domain signal are values that correspond to a respective adjacent signal peak (e.g. FIG. 9: peak #2, peak #3) which resides at a frequency that is not a harmonic frequency of the target ion (i.e. peak #1, the ion we wish to determine the charge of). For example, OP₁ may a value of the frequency-domain signal from within peak #1 corresponding to a frequency which is a harmonic of the motion of the target ion. This may be the value ‘observed’ to be the highest value within the signal peak #1 shape corresponding to a harmonic. Similarly, OPₙ (where n>1) may be values of the frequency-domain signal peaks #2 and #3 etc., corresponding respectively to a frequency which is a harmonic of the motion of another respective ion (i.e. N−1 other ions in total) that is not the target ion. Again, these adjacent peak values may each be a value ‘observed’ to be the highest value within the signal ‘peak’ shape corresponding to a harmonic.

With these N selected values of the frequency-domain signal (N=3 in FIG. 9) a set of equations is generated which represents the contributions (αₙₘ) made to each one of the selected separate values (OPₙ) of the frequency-domain signal, by the motion of all ions contributing to the signal associated with a given harmonic of the target ion.

The method includes solving this set of equations, one may obtain a corrected (i.e. ‘true’) value (TP₁) of the frequency-domain signal associated with a given harmonic of the target ion for which the spectral energy arising from the motion of the all other ions contributing to the signal at that frequency, is removed. The method also obtains a corrected (‘true’) value TPₙ (where n>1) of the frequency-domain signal associated with the adjacent harmonics of the non-target ion(s). These are the other ions which contribution spectral energy to the harmonic of the target ion.

In the example of FIG. 9, three separate values of the frequency-domain signal are selected, each corresponding to a respective one of three (N=3) signal peaks (peaks #1, #2 and #3). Each of these three peaks resides at a respective frequency that is a harmonic frequency of an ion contributing to the overall signal (i.e. the target ion and two other non-target ions). The above equation may be expressed as:

$${OP}_{1} = {α}_{11} {TP}_{1} + {α}_{12} {TP}_{2} + {α}_{13} {TP}_{3} \\ {OP}_{2} = {α}_{21} {TP}_{1} + {α}_{22} {TP}_{2} + {α}_{23} {TP}_{3} \\ {OP}_{3} = {α}_{31} {TP}_{1} + {α}_{32} {TP}_{2} + {α}_{33} {TP}_{3} \\ Here , \\ {α}_{nm} = {e}^{\frac{i ( {ω}_{mk} - {ω}_{n} ) {T}_{E}}{2}} * \frac{sin \frac{( {ω}_{m} - {ω}_{n} ) {T}_{E}}{2}}{{ω}_{m} - {ω}_{n}}$$

Where m refers to an ion oscillation at frequency ωₘ associated with an adjacent peak TPₘ, n refers to the frequency ωₙ of the component we are interested in.

Solving this set of simultaneous equation for: TP₁, TP₂, TP₃, provides a corrected value (e.g. TP₁, for the target ion) for any given one of the values of the frequency-domain signal to be used in the step of calculating the charge of the target ion, as described above.

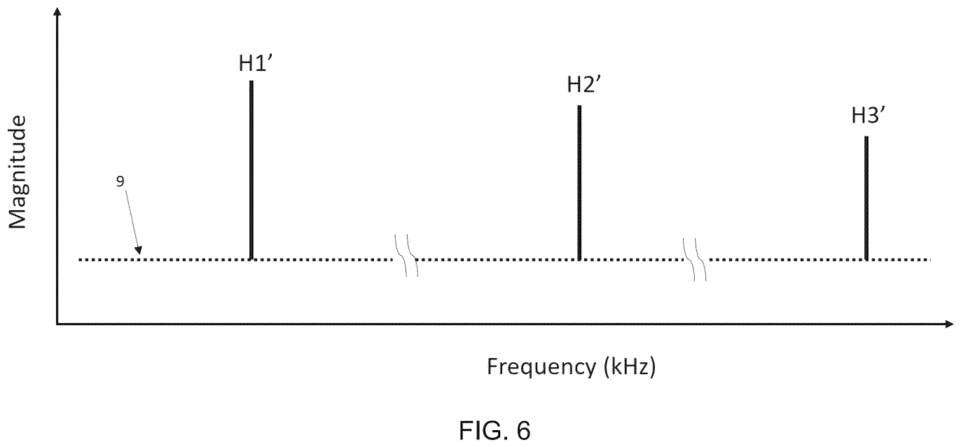

In other words, rather than simply using the ‘observed’ spectral peak value OP₁ from the respective harmonic peak (H1′ of FIG. 6) of the signal, the method may include using the ‘true’ spectral peak value TP₁ instead (i.e. OP₁→TP₁). The same procedure may be applied to each one of the values of the frequency-domain signal associated with the target ion (e.g. FIG. 6: the spectral peaks H1′, H2′ and H3′) to obtain:
(1) A ‘true’ spectral peak value TP₁⁽¹⁾ for the peak value of the harmonic spectral peak H1′;
(2) A ‘true’ spectral peak value TP₁⁽²⁾ for the peak value of the harmonic spectral peak H2′;
(3) A ‘true’ spectral peak value TP₁⁽³⁾ for the peak value of the harmonic spectral peak H3′;

These three ‘true’ spectral peak values (TP₁⁽¹⁾, TP₁⁽²⁾, TP₁⁽²⁾ be used in the step of calculating the target ion charge.

The values of the frequency-domain signal to be used in the step of calculating the target ion charge are values of the amplitude or magnitude of the complex numbers representing the frequency-domain signal. In general, both, OP and TP are complex numbers taken at certain points on frequency spectrum. A Fourier Transform of a signal gives a complex number for each frequency point. When constructing the matrix of linear equations, described herein, one uses these complex numbers. This enables linearity of the system of equations. After the solutions TP are found (complex numbers) one may calculate the magnitudes of these complex numbers determined by calculating: Magnitude=sqrt({Re[TP]}²+{Im[TP]}²)) This calculation may be done for several points for each harmonic of each peak. With the determined magnitude of the target peak to hand, the charge of the associated ion may be calculated.

By taking these phase differences into account, the corrected M separate values (TPₙ) of the frequency-domain signal may be more accurate.

With reference to FIG. 9, which shows part of a frequency spectrum of two ions one of which—the ion associated with peak #2—changed its oscillation frequency at some point during the capture of the recorded signal. One can see that there are three spectral peaks located at three differing frequencies in the illustrated spectrum. Peak #1 is the target frequency of the target ion, and peaks #2 and #3 are interferences.

If peak #1 had been the only spectral peak within the section of the spectrum shown in FIG. 9, then its power spectrum would be represented by a single ‘sinc-function’ and the task of establishing the magnitude of the spectral peak #1 for that frequency component would be straightforward. However, as can be seen from FIG. 9, when there are several frequency components (i.e. peaks #2 and #3), their individual spectra combine and, as a result, establishing the true magnitude of the target peak #1 is more complicated. Specifically, the observed spectral magnitude of peak #1, OP₁, is a combination of its ‘true’ magnitude, TP₁, and the contributions from peaks #2 and #3 that are proportional to their respective ‘true’ magnitudes.

If the phases of all three ions are the same, the above system of equations is linear with respect to the unknowns TP₁, TP₂ and TP₃. This is because the phase of a frequency component m is factored in its coefficients αₙₘ and if this is the same for all components then these additional factors may be reduced to a common factor. In that case, all αₙₘ depend only on the difference between frequency positions of the components n and m within the spectrum, as there is no variation in the value of the common phase factor within the above system of equations. If this assumption is true, for example, when all ions would be considered to start at the same time and their initial phase would be the same. However, this assumption is not the case in most of the real experimental scenarios. If we assume that the phases of all components are not the same, then the above system of equations should include the phase factors with different phases for each of the components. These phase factors are treated as additional unknows and the system of equations becomes non-linear.

The signal processing unit 91 comprises a processor or computer programmed to execute computer program instructions to perform the above signal processing steps upon image charge/current signals representative of trapped ions undergoing oscillatory motion. The result is a value representative of the charge on the ion. The ion analyser 80 further incudes a memory unit and/or display unit 93 configured to receive data 92 corresponding to the charge on the ion, and to display the determined charge value to a user and/or store that value in a memory unit.

FIG. 2b shows a schematic drawing of the recorded image-charge/current signal generated by the ion analyser apparatus of FIG. 2a. The signal consists of an acquired signal ‘transient’ that may typically be observed to exist for about a second, or less, and occurs when an ion undergoes oscillatory motion within an ion analyser apparatus (e.g. an ion trap) and in so doing induces an image-charge/current signal detectable by sensor electrodes of the apparatus configured for this purpose. The recorded image-charge/current signal comprises a plurality of pulses within the image-charge/current signal forming a periodic succession of repetitive signal pulses, with repetition period T. This one-dimensional time-domain image-charge/current signal is generated by an ion analyser 80 of FIG. 2a. The signal corresponds to the recorded image-charge/current signal 90 received by the signal processor 91 from the signal recording unit 89, and is representative of the oscillatory motion of one or more ions in the ion analyser apparatus. The signal consists of a sequence of regularly-spaced sequence of brief but intense, image-charge/current signal pulses (7 including: 7a, 7b, 7c, 7d, 7e, 7f, 7g, . . . and 8, etc.) each being separated, one from another, by intermediate intervals of mere noise in which no discernible transient signal pulse is present. Each signal pulse corresponds to the brief duration of time when an ion 85B, or a group of ions, momentarily passes between the two opposing image-charge/current sensing electrodes 87 of the electrostatic ion trap 80 during the oscillatory motion of the ion(s) within the ion trap.

The period of oscillations by definition is the time distance between two reflections e.g. states where ion kinetic energy is minimal and its potential energy is maximal. In symmetric systems, one can consider that an ion's oscillation period is the signal period.

A first pulse (7a) is generated when the ion(s) 85B passes the sensing electrodes 87, moving from left-to-right, during the first half of one cycle of oscillatory motion within the electrostatic trap, and a second pulse (7b) is generated when the ion(s) passes the sensing electrodes 87 again, this time moving from right to left during the second half of the oscillatory cycle. A subsequent, second cycle of oscillatory motion generates subsequent signal pulses (7c, 7d). The first half of the third cycle of oscillatory motion generates subsequent signal pulse (7e), and additional pulses follow as the oscillatory motion continues, one cycle after another.

Successive signal pulses are each separated, each one from its nearest neighbours, in the time-domain (i.e. along the time axis (t) of the signal), by a common period of time, T, corresponding to a period of what is, in effect, one periodic signal that endures for as long as the ion oscillatory motion endures within the electrostatic ion trap. In this way, the periodicity of the periodic signal is related to the period of the periodic, cyclic motion of the ion(s) within the electrostatic ion trap 80, described above. Thus, the existence of this common period of time (T) identifies the sequence of pulses (7, 8) as being a “periodic component” of the image-charge/current signal. Given that the common period of time, T, necessarily corresponds to a frequency (i.e. the inverse of the common time period), then this “periodic component” can also be described as a “frequency component”. The signal may be harmonic or may be non-harmonic, depending on the nature of the periodic oscillatory motion of the ion(s). Such a signal may be harmonic in the sense of having a waveform in the form of a sinusoidal wave. Otherwise it is non-harmonic which means it has one or more significant frequency components in addition to its fundamental harmonic component (e.g. e.g. other higher order harmonic frequency components, or non-harmonic frequency components).

The following method is an example of one possible way of determining the period, T, and the lifetime, T_{LT}, of the periodic component within the recorded image charge signal. However, other methods for determining the lifetime of the ion oscillatory motion may be used, such as would be readily apparent to the skilled person, e.g. Short-Time Fourier Transform (STFT) methods, and the STORI method discussed above.

FIG. 2c shows a schematic representation of a 2D function, F₂(t₁,t₂), comprising a stack of segmented portions of the image-charge/current signal, F₁(t), schematically shown in FIG. 2b. This is an example of the 2D function defined by the data 92 generated by the signal processor 91 and output to the display unit 93. The signal processor 91 is configured to determine a value (T) for the period of the periodic component (7a, 7b, 7c, 7d, 7e . . . etc.) within the image-charge/current signal, F₁(t), and then to segment the image-charge/current signal, F₁(t), into a number of separate successive time segments of duration corresponding to the determined period. The signal processor is configured to subsequently co-register the separate time segments in a first time dimension, t₁, defining the determined period (T). Next, the signal processor 91 separates the co-registered time segments along a second time dimension, t₂, transverse (e.g. orthogonal) to the first time dimension. The result is to generate a stack of separate, successive time segments arrayed along the second time dimension. Collectively, this array of co-registered time segments defines the 2D function, F₂(t₁,t₂), which varies both across the width of the stack in the first time dimension, t₁, according to time within the determined period, T, and also along the length of the stack in the second time dimension, t₂, according to time between successive time segments. Referring to FIG. 2c, the period, T, of the periodic component has been determined to be T=4.5 μsec, and the continuous 1D image-charge/current signal has been segmented into a plurality of time segments (7A, 7B, 7C, 7D, 7E . . . etc.) each being 4.5 μsec in duration. Each one of the time segments of the plurality of time segments has been co-registered with each one of the other time segments of the plurality of time segments. This means that the first time segment 7A is selected to serve as a “reference” time segment against which all other time segments are co-registered. To achieve this co-registration, the time coordinate (i.e. the first time dimension t₁) of each signal data value/point in a given time segment, other than the “reference” time segment1 is subject to the following transformation of 1D time (t) into 2D time (t₁, t₂), in order to implement a step of segmenting the recorded signal into a number of separate time segments. The result is to convert the 1D function, F₁(t), into the 2D function, F₂(t₁, t₂), according to the relation:

$$t \to {t}_{1} + {t}_{2} \\ {F}_{1} ( t ) \to {F}_{2} ( {t}_{1} , {t}_{2} ) ∼ {F}_{1} ( {t}_{1} + {t}_{2} ) .$$

Here the variable t₁ is a continuous variable with values restricted to be within the time segment, [0;T], ranging from 0 to T, where T is the period of the periodic component. The variable t₂ is a discreet variable with values constrained such that t₂=mT, where m is an integer (m=1, 2, 3 . . . , M). The upper value of m may be defined as: M=T_{acq}/T, where T_{acq} is the ‘acquisition time’, which is the total time duration over which all of the data points are acquired.

In other words, segmentation may be performed by enforcing these restrictions, such that each separate value of the integer ‘m’ defines a new segment and a step along the second time dimension, t₂. Each segment has a time-duration, in the first time dimension t₁, ranging from t₁=0 to t₁, =T only. This also means that the beginning time point of each segment shares the same value of the continuous time variable t₁ (i.e. t₁=0) with the beginning time point of every other segment, but has a unique value of time t₂ in the second time dimension Similarly, this also means that the end time point of each segment shares the same value of the continuous time variable t₁ (i.e. t₁=T) with the end time point of every other segment, but has a unique value of t₂ in the second time dimension. In this sense, the different segments are “co-registered” (i.e. aligned in time) with each other in the 2D space of the 2D function, F₂(t₁, t₂). Of course, it is to be understood that the actual sampled value of the image-charge/current signal are discrete values which are sampled at a finite number of discrete time points within the continuous time interval, [0;T]. This means that actual measured signal values may or may not exist (depending on the sampling rate etc.) at the exact point in time: t₁=0, t₁=T, in the segments.

For example, the step of segmenting the recorded signal into a number of separate time segments may include converting the 1D function, F₁(t), into the 2D function, F₂(t₁, t₂), according to the relation:

$${F}_{nm} ∼ {F}_{1} ( \frac{n}{N} T + mT ) \\ Here , \\ \frac{n}{N} T = {t}_{1} , mT = {t}_{2}$$

In addition, the integer N denotes the number of data points (measurements or samples) that are available within the segment time interval [0;T]. For example, the data sampling time interval, δt, may be such that δt=T/N, and the counting integer ‘n’ varies in the range n=1, 2, . . . , N. In other words, the step of segmenting may produce a matrix, Fₙₘ, of data values comprising ‘m’ rows and ‘n’ columns. Each row of the matrix defines a unique segment, with successive rows defining a ‘stack’ of segments. The ‘row’ dimension of the row of the matrix corresponds to the first time dimension, t₁, whereas the ‘column’ dimension of the matric corresponds to the second time dimension, t₂. In this sense, the different segments are “co-registered” (i.e. aligned in time) with each other, and “separated” from each other, in the 2D space of the 2D function, F₂(t₁, t₂).

The result is equivalent to a common time displacement or translation (schematically represented by item 25 of FIG. 2c) in a negative time direction along the first time dimension sufficient to ensure that the translated time segment starts (21, 23, . . . etc.) at time t₁=0 and ends (22, 24, . . . etc.) at time t₁=T=4.5 psec. The result is that each time segment (7A, 7B, 7C, 7D, 7E . . . etc.) receives its own appropriate time translation (see item 25 of FIG. 2c) sufficient to ensure that all time segments extend only within the time interval [0;T] along the first time dimension.

It is important to note that this registration process applies to time segments as a whole and does not apply to the location of transient signal pulses (7a, 7b, 7c, 7d, 7e, . . . etc.) appearing within successive time segments. However, if the time period, T, for the periodic signal component has been accurately determined, then the result of co-registering the time segments will be the consequential co-registration of the transient signal pulses, and the position of successive transient pulses along the first time dimension, will be static from one co-registered time segment to the next. This is the case in the schematic drawing of FIG. 2c, in which we see that the transient signal pulses align along a linear path parallel to the axis of the second time dimension.

Conversely, if the time period, T, for the periodic signal component has not been accurately determined, then the result of co-registering the time segments will not result in a co-registration of the transient signal pulses, and the position of successive transient pulses along the first time dimension, will change/drift from one co-registered time segment to the next.

The signal processor 91 subsequently displaces, or translates, each one of the co-registered time segments along a second time dimension, t₂, which is transverse (e.g. orthogonal) to the first time dimension. In particular, each signal data value/point in a given time segment, other than the “reference” time segment1 is assigned an additional coordinate data value such that each signal data point comprises three numbers: a value for the signal; a time value in the first time dimension and a value in the second time dimension. The first and second time dimension values, for a given signal data point, define a coordinate in a 2D time plane, and the signal value associated with that data point defines a value of the signal at that coordinate. In the example shown in FIG. 2c, the signal value is represented as a “height” of the data point above that 2D time plane.

The time displacement or translation applied along the second time dimension is sufficient to ensure that each translated time segment is spaced from its two immediately neighbouring co-registered time segments, i.e. those immediately preceding and succeeding it, by the same displacement/spacing. The result is to generate a stack of separate, successive time segments arrayed along the second time dimension, which collectively defines the 2D function, F₂(t₁,t₂), as shown in FIG. 2c. This function varies both across the width of the stack in the first time dimension, t₁, so as to indicate the position and shape of the transient signal pulse within the time [0;T], and also along the length of the stack in the second time dimension, t₂, according to time between successive time periods, or stack-segment number. Since the time interval between the beginning of the n^{th} and (n+1)^{th} stack, or between any two points with the same coordinate in the first time dimension, is necessarily equal to the time period, T, then the successive time segments are inherently spaced along the second time dimension by a time interval of T seconds (e.g. 4.5 μsec in the example of FIG. 2c).

FIG. 2d schematically represents the procedure for determining a value, T, for the period of the periodic signal component within the image-charge/current signal, F₁(t), in the method for generating the 2D function F(t₁,t₂). The first step in the method is to generate an image charge/current signal, and then to record the image charge/current signal in the time domain.

The acquired recording of the one-dimensional time domain image-charge/current signal, F₁(t) of FIG. 2d, contains one or more periodic oscillations. These periodic components may correspond to frequency components f₁=1/T₁, f₂=1/T₂ . . . etc.

Subsequently, the next step of the method determines a period (T) for a periodic signal component within the recorded signal, and this step may comprise the following sub-steps:
(1) A first sub-step is to sample the one-dimensional time domain signal F₁(t) of FIG. 2d, with a sampling step of size “δt”.
(2) A second sub-step is to estimate a value for the time period, Tᵢ(i=1, 2, . . . ), of each of the periodic/frequency components f₁=1/T₁, f₂=1/T₂ . . . etc. This may be done by means of any suitable spectral decomposition method as would be readily apparent to the skilled person, or may be done purely by initially guessing those values and applying the present methods iteratively until a consistent result is found.
(3) A third sub-step is to segment the one-dimensional signal, F₁(t), and co-register the time segments according to a chosen period (frequency) value, fᵢ=1/Tᵢ, so as to form the 2D function F(t₁,t₂). In particular, the argument t₁ starts at t₁=0 (zero) and every subsequent sampling step increases along the t₁ axis by a step-size “δt”: initially the argument t₂=0 (zero) during this process. After time t₁ is equal to or greater than T has been reached, the argument t₁ is reset to t₁=0 (zero) and the argument t₂ increases by a step size of T, i.e. t₂=T. Thus, each sampling point of the measured signal is attributed to a pair of values, (t₁, t₂). In this way a 2D mesh/plane (t₁, t₂) is formed. This constitutes a “separating” of the co-registered time segments along a second time dimension, t₂, transverse to the first time dimension thereby to generate a stack of time segments collectively defining a 2-dimensional (2D) function. The resulting function F₂(t₁,t₂) can be thought of as a set of layers F(t₁) where t₁ is always within interval [0;T] and each layer corresponds to a certain t₂ having a constant value (an integer multiple of T) within the layer.
(4) A fourth sub-step, according to a first option, is to generate a first 2D scatter graph such that F(t₁, t₂=fixed), ignoring variation in t₂ values, corresponds to viewing F₂(t₁,t₂) along “View (a)” of FIG. 2c, and will result in all layers been seen to overlap onto each other. For a proper choice of segment period, T, a peak can be seen above noise area, as shown in FIG. 2e.
(5) A fourth sub-step, according to a second option, is to generate a second 2D scatter graph which corresponds to viewing F₂(t₁,t₂) along “View (b)” of FIG. 2c, showing F₂(t₁,t₂) subject to the following condition: plot point (t₂;t₁) if |F₂(t₁,t₂)|<C where C is predetermined threshold value (e.g. a pre-defined signal level), otherwise skip/omit it from the plot. For a proper choice of segment period, T, a clear channel of width Δt₁ in FIG. 2f, substantially free of data points, will appear to extend along a path parallel to the t₂ axis, surrounded/bounded by points as shown in FIG. 2f. It is to be understood that the condition |F₂(t₁,t₂)|>C is also possible, and this condition this will make a ‘filled’ channel with clear space around it in the 2D space.

The value for the period, T, may be arrived at iteratively, using procedures (4) or/and (5) to decide whether the chosen period value corresponding to a frequency component of signal F₁(t). This decision may be based on certain criteria. For example, according to method step (4), if the representation of F₂(t₁,t₂) contains a peak-shaped dense area then this is categorized as a frequency component. Examples are shown in FIG. 2e. Alternatively, or in addition, according to method step (5), for a pre-defined signal threshold level, C, if the representation of F₂(t₁,t₂) contains a clear and substantially straight channel (item 6 of FIG. 2f) extending along a path parallel to t₂ axis, then this is categorized as a frequency component. An example is shown in FIG. 2f. Both methods provide a means of identifying when the chosen segment period, T, (i.e. the length of each time segment) accurately matches the actual time period of the periodic component within the signal, F₁(t). Only then will each transient peak of the periodic component in successive time segments ‘line-up’ in a linear fashion along a path parallel to the axis of the stacking dimension (t₂). If the chosen segment period, T, does not accurately match the actual time period of the periodic component within the signal, F₁(t), then the transient peak of the periodic component in successive time segments will not ‘line-up’ in a linear fashion along a path parallel to the axis of the stacking dimension. Instead, the peaks will drift along a path diverging either towards the axis of the stacking dimension, or away from it.

Non-iterative methods of determining the frequency are also possible. Such methods may be faster. For example, suppose that the period of the periodic component that is initially determined, is slightly incorrect (i.e. T′≠T, but not by much). The result is a linear feature extending through the 2D space of the 2D function in a direction inclined to the second time dimension (t₂ axis). One may find the period corresponded to this signal iteratively as described above, by iteratively re-segmenting and re-stacking the original 1D signal again and again until the linear feature is made parallel to the t₂ axis. Alternatively, one can determine an inclination angle which the linear path of the linear feature subtends to the axis of the first time dimension (e.g. with respect to t₁ axis) and get correct stacking period (i.e. T′=T), according to that angle (i.e. the angle between the t₁ axis and linear path direction). The advantage is one does not need to perform iterative re-segmenting and re-stacking at all. This saves lots of computational time because usually a signal array in memory is a very large amount of data and accessing such arrays in a PC memory is a long process and is a bottleneck in processing speed. Once one has determined the inclination angle, the formula for the correct period, determined using the ‘incorrect’ stacking period (T′) and the inclination angle, is:

$$\frac{1}{T} = \frac{1}{{T}^{′}} ( 1 + \frac{1}{tan ( α )} )$$

The inclination angle, α, can be measured directly, and may be iteratively optimized by successive measurements of the inclination angle, α, made by successive versions of the linear feature for successive (improving) values of stacking period (T′). In this way, the inclination angle, α, can be used as an optimisation variable to find the condition T′=T. Optimization methods readily available to the skilled person (e.g. gradient descent) or by machine learning tools (e.g. neural networks) may be used to implement this.

Either method, namely method (4) or method (5), may be performed either by image analysis algorithms or by numerical algorithms. Preferably, such algorithms would consider the density, or number, of data points on the respective representation of F₂(t₁,t₂). For example, an algorithm may determine the number of points falling below a pre-defined threshold |F₂(t₁,t₂)|<C within a pre-defined time interval Δt₁ within the first time dimension. If the density, or number, of points is less than the threshold, C, then this may be used to indicate that the frequency component is suitably detected. FIG. 2f exemplifies this method. Here the method includes determining a sub-set of instances of the 2D function in which the value of the 2D function falls below the pre-set threshold value, C. From amongst that sub-set of instances one determines the interval of time, Δt₁, in the first time dimension during which the 2D function never falls below the pre-set threshold value. One may then identify that interval of time as being the location/presence of the priodic signal component.

Algorithms may employ machine learning techniques including neural networks trained to classify images having resolved peak structures (method (4)) and/or noticeable channels (method (5)).

Once a value for the period, T, has been arrived at iteratively, the method proceeds by segmenting the recorded signal into a number of separate successive time segments of duration corresponding to the determined period. The procedure for doing this is the same as that described in the sub-step (3). It will be appreciated that, according to the iterative method of determining the time period, T, one inherently performs method sub-step (3) when one implements the final, successful sub-step (4) or (5) described above.

The final step of the method is to generating a stack of the time segments of the previous step, in a second time domain, t₂, to generate a stacked image charge/current signal. The procedure for doing this is the same as that described in the sub-step (3) for co-registering the separate time segments in a first time dimension, t₁, defining the determined period, T, and of separating the co-registered time segments along the second time dimension, t₂, transverse to the first time dimension. Once more, according to the iterative method of determining the time period, T, one inherently performs the final step when one implements the final, successful sub-step (4) or (5) of step S3, described above.

In this method the signal processing unit may be programmed to determine the value, T, for the period of a periodic signal component iteratively in this way. It may initially estimate a ‘trial’ value of T, as described above, and segment the recorded signal, F₁(t), using that ‘trial’ value, into a number of time segments of duration corresponding to a ‘trial’ period, and co-registering them, then separate the co-registered time segments along the second time dimension, t₂, to generate a stack of time segments. The signal processor unit may be configured to automatically determine whether the position of the periodic component (transient peak) in the first time dimension changes along the second time dimension. If a change is detected, then a new ‘trial’ time period, T, is chosen by the signal processor and a new stack of time segments is generated using the new ‘trial’ time period. The signal processor then re-evaluates whether the position of the periodic component (transient peak) in the first time dimension changes along the second time dimension, and the iterative process ends when it is determined that substantially no such change occurs. This condition signifies that the latest ‘trial’ time period, T, is an accurate estimate of the true time period value.

With the value (T) of the period of the oscillatory motion of the target ion to hand, one may then proceed by truncating the recorded signal, F₁(t), as follows.

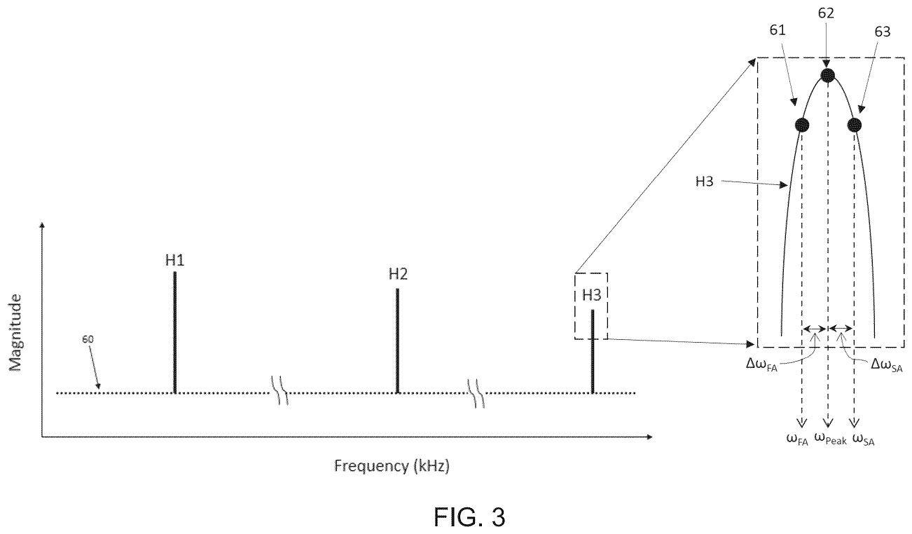

Referring to FIGS. 3, 4 and 5, there is illustrated a procedure for truncating the recorded signal to provide a truncated signal having a duration substantially equal to an integer multiple (N×T) of period (T) of the period of the oscillatory motion of the target ion.

In particular, FIG. 3 shows a schematic view of a Fourier spectrum, in the frequency-domain, resulting from applying a Fourier transform to the recorded signal, F₁(t). The Fourier spectrum possesses multiple clear spectral peaks (H1, H2, H3) rises clearly above a background spectral signal level 60. The first spectral peak, H1, is located at a lower frequency than the location of the second and third spectral peaks (H2, H3). This peak corresponds to the frequency of a first (fundamental) harmonic of the oscillatory motion of the target ion and encompasses a narrow range of frequencies including the fundamental frequency (f₀=1/T, Hz) of the oscillatory motion of the target ion.

A second spectral peak, H2, is located at a mid-frequency between the location of the first and third spectral peaks (H1, H3). This peak corresponds to the frequency (2f₀=2/T Hz) of a second harmonic (first overtone) of the oscillatory motion of the target ion and encompasses a narrow range of frequencies including the fundamental frequency of the oscillatory motion of the target ion.

A third spectral peak, H3, is located at a higher frequency beyond the location of the first and second spectral peaks (H1, H2). This peak corresponds to the frequency (3f₀=3/T Hz) of a third harmonic (second overtone) of the oscillatory motion of the target ion and encompasses a narrow range of frequencies including the fundamental frequency of the oscillatory motion of the target ion. Other spectral peaks exist (not shown) at ever higher harmonic frequencies within the Fourier spectrum. Higher harmonics are responsible for the peak shape in the time domain within the recorded signal, F₁(t). The decay of the recorded signal in the time domain is characterised by the peak shape in the frequency domain. For example, the shape of the decay of the signal peaks 8 within the recorded signal shown in FIG. 5. This decay in signal peaks begins when the regular oscillatory motion of the target ion begins to die and the oscillatory motion becomes more complex and contaminated with significant spectral (frequency) components that are not pure harmonics such as H1, H2 and H3 etc. The ‘lifetime’ of the regular oscillatory motion of the ion has at that point in time effectively expired.

The procedure for truncating the recorded signal, to provide a truncated signal, aims to remove from the recorded signal those parts that are not within the ‘lifetime’ of the target ion, thereby to ‘clean’ the recorded signal before subsequent analysis of it.

It is necessary to determine an accurate estimate for the point in time (T_{Life}) as measured from the beginning of the recorded signal, F₁(t), at which the ‘lifetime’ of the regular oscillatory motion of the ion has expired, and thereby estimate which parts of the recorded signal to remove by truncation. To perform this estimate, one may select as the truncated signal the sub-portion of the recorded signal which starts at a recorded time coinciding with (or after) the recorded start time of the recorded image-charge/current signal and ends at a recorded time before the recorded end time of the recorded image-charge/current signal.

The truncated signal may be a sub-portion of the recorded signal within which a sequence of repeating signal peaks reside which each have a respective peak signal value which deviates by not more than about 20% from the value of the largest peak value amongst the sequence of repeating signal peaks.

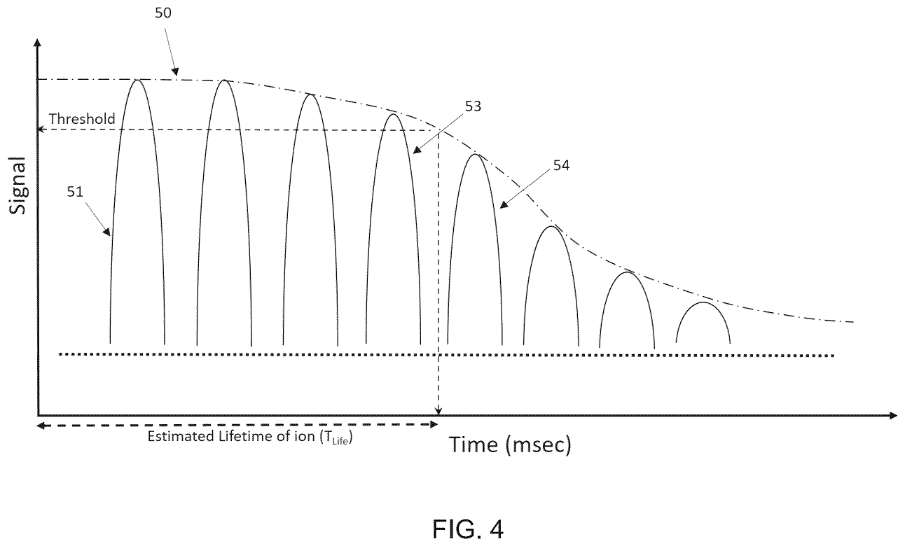

Alternatively, the truncating of the recorded signal may comprise the following steps illustrated with reference to FIG. 3 and FIG. 4:
(1) First, the recorded signal, F₁(t), is transformed into a frequency-domain, such as by applying a Fourier transform to it. This results in a spectrum such as shown in FIG. 3, thereby to generate a transformed recorded signal.
(2) Selecting a harmonic spectral peak (e.g. H3) from within the spectrum. From within the selected harmonic peak:
   a. Select a peak value (ω_{Peak}, e.g. the maximum value 62) of the transformed recorded signal within the selected harmonic peak; then,
   b. Select a first adjacent value 61 (ω_{FA}) of the transformed recorded signal within the selected harmonic peak and corresponding to a frequency less than the frequency associated with the peak value by an amount Δω_{FA}; then,
   c. Select a first adjacent value 63 (ω_{SA}) of the transformed recorded signal within the selected harmonic peak and corresponding to a frequency greater than the frequency associated with the peak value by an amount Δω_{SA}. (e.g. |Δω_{FA}|=|Aω_{SA}|).
(3) Reconstruct a time-domain signal (51, 53, 54) as shown in FIG. 4, based on the selected peak value 62, the selected first adjacent value 61 and the selected second adjacent value 63. Reconstruction produces an approximate version, F_{1Approx}(t), of the recorded signal F₁(t) based purely on a few selected samples from within a spectral harmonic peak within the frequency spectrum of the recorded signal.
(4) Determine a threshold time (T_{Like}) at which an amplitude modulation 50 within the reconstructed time-domain signal falls below a threshold signal value. This threshold value may be set at about 80% of the maximum value of the first signal pulse 51, or of the maximum value of the amplitude modulation envelope 50. For example, in the schematic of FIG. 4, the first signal pulse 51 has an amplitude substantially matching the amplitude modulation envelope 50, and the fourth signal pulse 53 has an amplitude which is less than that of the first pulse, it being modulated by the amplitude modulation envelope 50, but still exceeds the threshold level. However, the fifth signal pulse 54 has an amplitude which is less than the threshold, it being further modulated by the amplitude modulation envelope 50. As a consequence, the threshold time (T_{Life}) falls at a time between the times of pulses 53 and 54.
(5) Truncate the recorded signal according to the threshold time (T_{Life}) so determined.

It has been found that this method of reconstructing a version of the time-domain signal using only a few (e.g. three) frequency samples selected at and around the top of a spectral harmonic peak, is effective at capturing sufficient spectral information necessary to determine an accurate estimate for the time point at which the ‘lifetime’ of the regular oscillatory motion of the ion has expired, and thereby estimate which parts of the recorded signal to remove by truncation. This method captures spectral information more specifically associated with the dynamics of the target ion and less contaminated by information regarding noise or regarding the dynamics of other interfering ions present in the recorded signal, F₁(t). A suitable spectral peak has been found to be one which is a higher harmonic (the further from the fundamental harmonic the better) which is ‘strong’ in the sense of being a sufficiently large peak not excessively influenced by noise (e.g. a sufficiently high signal-to-noise ratio).

With the value of the ‘lifetime’ of the ion oscillatory motion to hand, together with a value of the period, T, of the oscillatory motion of the ion, one may proceed to truncate the recorded signal, F₁(t) by defining a ‘truncated lifetime’ (T_{trunc}) of the ion which satisfies the following two conditions:
(1) The ‘truncated lifetime’ is substantially equal to an integer (N) multiple of the period (T) of the oscillatory motion of the target ion: i.e. T_{trunc}=N×T.
(2) The ‘truncated lifetime’ is less than the ‘lifetime’ (T_{Life}) of the regular oscillatory motion of the ion.

FIG. 5 shows this relationship schematically.

Processing of a ‘cleaner’ version of the time-domain signal may then proceed based on frequency-domain harmonic components (e.g. H1′, H2′, H3′ . . . etc., in FIG. 5) from within this truncated time-domain signal. That is to say, the method proceeds by applying a transform of the truncated signal, such as a Fourier transform, to provide a frequency-domain spectrum of the truncated time-domain signal. From this spectrum, a selection is made of one or more values of the spectral signal corresponding to a respective one or more harmonic peaks within the spectrum.

On the basis of these one or more values of the spectral signal the ‘cleaner’ version of the frequency-domain signal is used for calculating the charge of the target ion. FIGS. 5 and 6 illustrate aspects of this process schematically.

This method provides a means for estimating ion charge values based on ‘cleaning’ of the image-charge/current signal's frequency spectrum, followed by reconstitution of the signal from this ‘cleaned’ frequency spectrum. Whereas, in the prior art, ‘cleaning’ of a frequency spectrum is usually done by removing or modifying all of the frequency components of the spectrum that are deemed to be noise or non-essential, the present invention implements a different strategy. For example, in CDMS, once an ion oscillation is identified in a Fourier spectrum, we are interested in the magnitudes of spectral peaks, which means that the ‘useful’ components of a spectrum are frequency ranges around peak tops. Noise frequencies that fall within those frequency ranges cannot be removed during prior art spectrum ‘cleaning’ methods.

However, in the present method illustrated by FIG. 5, one reduces (truncates) the size of the input time-domain image-charge/current signal data set, so that it covers e.g. slightly less than the ‘lifetime’ of ion oscillation and so that the duration of the truncated data set substantially equals to an integer number of period (T=1/F) of the fundamental harmonic of oscillatory motion of the target ion. This makes the time-domain signal approximately satisfy the ideal periodical boundary condition, and, after application of a frequency transform (e.g. Fourier transform) to the truncated time-domain signal, the target frequency spectral peaks (harmonic peaks) in the frequency domain spectrum become much narrower (e.g. an equivalent of the delta function), in the present method illustrated by FIG. 6. This makes the task of selecting a spectral peak value, from within a spectral peak, much more accurate—i.e. selecting the peak value of a very narrow peak shape, as opposed to a broader peak shape. The act of truncating the recorded image-charge signal to be not greater than the lifetime of the oscillatory motion of the ion is responsible for the majority of the narrowing of the spectral peaks. The act of additionally truncating the recorded image-charge signal so that its duration is also equal to an integer number of periods, T, is responsible for reducing scalloping loss in the frequency-domain signal.

### Effects of Signal Truncation on Fourier Spectral Values

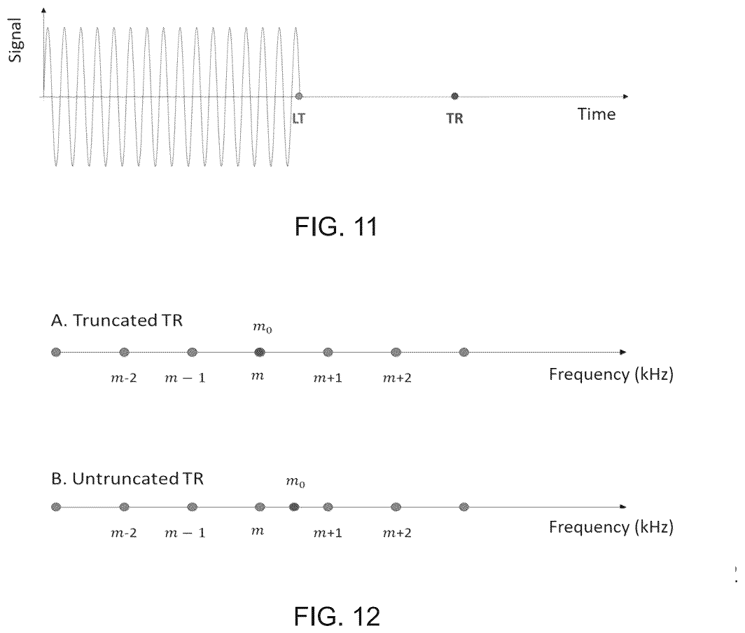

Without wishing to be bound by theory, the following discussion aims to provide a better understanding of the invention by reference to illustrative theoretical principles and notional examples. To aid a better understanding of the invention, the following discussion explores the effects of truncation of a notional, idealised image-charge current signal of total duration TR which includes within it a pure sinusoidal wave with the period T₀ and lifetime duration LT≤TR (see FIG. 11). This discussion is particularly interested in illustrating the effects of truncation of this signal on its Fourier spectrum.

The following aims to show how the truncation of the length of the signal, TR, to an integer multiple of the periods T₀ affects the signal's Fourier spectrum. Of particular interest are the following two cases:

$$When LT = TR \qquad ( 1 )$$

$$When LT < TR . \qquad ( 2 )$$

A general formula which is derived below (see ‘Theoretical Background’) for the spectral value A(ω) of the Fourier spectrum of the signal A_{ω0} cos(ω₀t+φ), at a frequency point ω, is:

$$A ( ω ) = {A}_{{ω}_{0}} * {e}^{i φ} * {e}^{\frac{i ( {ω}_{0} - ω ) ( {T}_{S} + {T}_{E} )}{2}} * \frac{sin \frac{( {ω}_{0} - ω ) ( {T}_{E} - {T}_{S} )}{2}}{{ω}_{0} - ω}$$

Here, ω₀ is the frequency of the sinusoidal wave (we do not differentiate between the sine and cosine since that is merely a matter of choosing the phase); φ is the initial phase of the sine wave; A_{ω0} is its amplitude; T_{S} and T_{E} are, respectively, the start and end times of the sine wave.

For simplicity, we set A_{ω0}=1, φ=0, T_{S}=0, T_{E}=LT. With this, the above formula transforms into the following expression:

$$A ( ω ) = {e}^{\frac{i ( {ω}_{0} - ω ) LT}{2}} * \frac{sin \frac{( {ω}_{0} - ω ) LT}{2}}{{ω}_{0} - ω} = \frac{LT}{2} * {e}^{iy} * sinc ( y ) \\ Here , \\ y = \frac{( {ω}_{0} - ω ) LT}{2} and sinc ( x ) = \frac{sin ( x )}{x}$$

Of interest is the magnitude, M(ω), of A(ω), and the above can be reduced to:

$$M ( ω ) = \vert A ( ω ) \vert = \frac{LT}{2} * sinc ( y )$$

Note that if ω→ω₀, then y→0 and M(ω)→LT/2 and this value does not depend on TR. The discrete Fourier transform (DFT) of a signal of duration TR results in a sequence of spectral values equally spaced along the frequency axis with the distance between two adjacent points (frequency bins) given by:

$$Δ f = \frac{1}{TR}$$

Thus, the values of ω where spectral values exist are given by:

$${ω}_{m} = \frac{2 π m}{TR}$$

where 0≤m≤N and N is the total number of signal samples. Note that while the values of ωₘ are defined completely by the value of TR, ω₀ is arbitrary and it may or may not coincide with one of the ωₘ. Thus, we can re-write the expression:

$$y = \frac{( {ω}_{0} - ω ) LT}{2}$$

in terms of indexes m₀ and m, as:

$$y = \frac{π ( {m}_{0} - m ) LT}{TR} = π ( {m}_{0} - m ) γ$$

where γ=LT/TR, index m is always an integer number and index m₀ is not necessarily an integer number. If we want m₀ to be integer, then TR must satisfy the condition:

$$TR = \frac{2 π {m}_{0}}{{ω}_{0}} = {T}_{0} * {m}_{0}$$

In other words, TR must be truncated to an integer number of periods T₀. The final expression for M(ω) becomes:

$${M}^{′} ( m ) = \frac{L T}{2} * \frac{sin [ π ( {m}_{0} - m ) γ ]}{π ( {m}_{0} - m ) γ}$$

Note that, strictly speaking, M and M′ are different functions. Let us consider scenarios:
(A) with m₀ coinciding with one of the frequency bins which happens when TR is truncated to an integer number of T₀'s; and
(B) with m₀ half-way between two adjacent frequency bins. This is the ‘worst case’ scenario with a non-truncated TR, as is schematically shown in FIG. 12.

Table 1 below shows the values of:

$$\frac{2}{L T} {M}^{′} ( m )$$

for scenarios A and B above for different values of γ=LT/TR:

TABLE 1

| | LT/TR | m | m-1 | m-2 |
|---|---|---|---|---|
| A. Truncated | 1.00 | 1.000 | 0.000 | 0.000 |
| B. Untruncated | | 0.637 | 0.212 | 0.127 |
| A. Truncated | 0.90 | 1.000 | 0.109 | 0.104 |
| B. Untruncated | | 0.699 | 0.210 | 0.100 |
| A. Truncated | 0.50 | 1.000 | 0.637 | 0.000 |
| B. Untruncated | | 0.900 | 0.300 | 0.180 |
| A. Truncated | 0.10 | 1.000 | 0.984 | 0.935 |
| B. Untruncated | | 0.996 | 0.963 | 0.900 |

Table 1 shows that the extent of benefits from truncation of the signal depends on the LT/TR ratio. In particular, if the input signal contained no noise at all, then truncate the signal would provide no noise-reduction benefit. In that case one would be able to reconstruct the underlying sinc function using any two spectral values selected from the frequency axis.

However, the situation is quite different in the presence of noise. In this case it is important to get as high signal-to-noise (S/N) ratio in the input data, as possible. This is because the higher the S/N, the less distortion by noise we get in the unput data and, therefore, in the useful information we extract from those data. If we are interested in estimating spectral values at (or close to) the apexes of spectral peaks in the Fourier spectrum, then truncation will result in improvement of the S/N ratio (e.g. see the values for column ‘m’ in the above table).

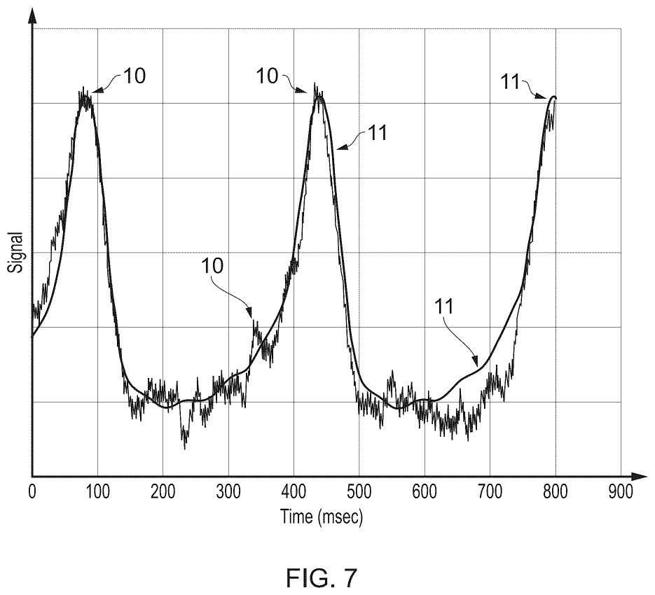

FIG. 7 shows the result of the reconstructed time-domain image-charge/current signal 11 after the ‘cleaning’, together with the original recorded image-charge/current signal 10 for comparison. The reconstructed signal 11 has unnecessary noise eliminated which makes it easy to measure the magnitude of the image charge signal accurately.

In cases where the target ion's oscillatory motion has a well-defined period, thereby having very well defined dominant harmonic frequency values in its frequency spectrum, the frequency spectrum of the truncated signal may comprise very ‘sharp’ and spectral components allowing accurate determination of an appropriate peak spectral signal value at the top of a given spectral peak, in the present method illustrated by FIG. 6. In cases where the target ion's oscillatory motion is non-harmonic, such as the motion one expects from the ELIT or the Orbital frequency analyser, the widths of spectral peaks broadens and all spectral points apart from those at harmonic frequencies (i.e. integer multiples of the fundamental harmonic frequency, F₀. e.g. F=nF₀ for n=1, 2, 3, . . . ) represent noise and are non-essential signals to be removed by the above ‘cleaning’ process. This maximises the reduction of noise-related spectral power from the image-charge/current signal's frequency spectrum. After such ‘cleaning’, far fewer data points remain in the frequency spectrum. The width (and shape) of an isolated spectral peak defines the envelope of the respective time domain signal. It is not (generally speaking) noise or non-essential signal.

### Theoretical Background

Without wishing to be bound by theory, the following discussion aims to provide a better understanding of the invention, e.g. in relation to the use of the simultaneous equations defined above, by reference to illustrative theoretical principles and notional examples.

### The Problem to Solve

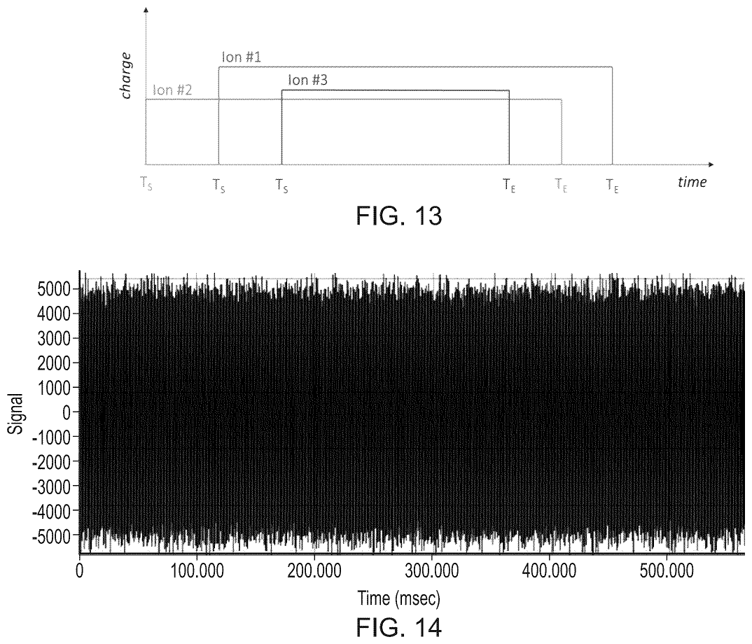

Assume an image-charge current signal of a known length produced by oscillating ions of different charges. An ion may ‘appear’ at an arbitrary moment of time, T_{S}, and ‘disappear’ at an arbitrary moment of time T_{E}. By definition, lifetime of an ion is LT=T_{E}−T_{S}. This is illustrated in FIG. 13. The task is to determine the charges of the ions. Neither T_{S} nor T_{E} are known, nor is the number of ions. In addition, in many real experiments the level of noise may exceed the level of the useful signal by almost two orders of magnitude, so that no individual ions' contributions are discernible by eye in the time domain signal as shown in FIG. 14.

### Fourier Transform

One can take the Fourier Transform (FT) of the time domain image-charge current signal and obtain its frequency spectrum. However, estimation of the charges may become less accurate if these ions undergo oscillatory motion at very similar frequencies leading to spectral interference. The heights of the peaks in the frequency spectrum depend not only on the ions' charges, but also on their ‘lifetimes’ (LT). In addition, the widths of these peaks depend on ion ‘lifetimes’ (LT), and adjacent peaks may interfere with each other as illustrated in FIG. 9. FIG. 9 shows part of a frequency spectrum of two ions one of which—the ion associated with peak #2—changed its oscillation frequency at some point during the capture of the recorded signal. One can see that there are three spectral peaks located at three differing frequencies in the illustrated spectrum. Peak #1 is the target frequency of the target ion, and peaks #2 and #3 are interferences.

If peak #1 had been the only spectral peak within the section of the spectrum shown in FIG. 9, then its power spectrum would be represented by a single ‘sinc-function’ and the task of establishing the magnitude of the spectral peak #1 for that frequency component would be straightforward. However, as can be seen from FIG. 9, when there are several frequency components (i.e. peaks #2 and #3), their individual spectra combine and, as a result, establishing the true magnitude of the target peak #1 is more complicated. Specifically, the observed spectral magnitude of peak #1, OP₁, is a combination of its ‘true’ magnitude, TP₁, and the contributions from peaks #2 and #3 that are proportional to their respective ‘true’ magnitudes.

One can establish from the peaks within the spectrum of FIG. 9 the number of oscillating ions (three) and their frequencies. Each peak corresponds to a different ion and, using higher harmonics of the signal, the frequencies of these ions can be established with reasonable accuracy. Further analysis may be p[referable to improve the accuracy of an estimate of the charges of those ions. This is because the heights of the peaks depend on the charges, the LTs of the respective ion image-charge current signal, and any contributions/interferences from the adjacent peaks. For example, the three peaks in FIG. 9 were produced by ions with the same charge of 50e. For each peak, one can say that its observed peak height, OP, is a combination of its true peak height, TP, and contributions of the adjacent true peak heights. Each peak's contribution could be expressed as αTP, where TP is the true (yet unknown) height of the peak and a is a coefficient that depends on the ion's LT and charge.

Thus, for N ions we have a system of equations:

$$\begin{matrix}{OP}_{1} = {α}_{11} {TP}_{1} + {α}_{12} {TP}_{2} + … + {α}_{1 N} {TP}_{N} \\ {OP}_{2} = {α}_{21} {TP}_{1} + {α}_{22} {TP}_{2} + ⋯ + {α}_{3 N} {TP}_{N} \\ … \\ {OP}_{N} = {α}_{N 1} {TP}_{1} + {α}_{N 2} {TP}_{2} + … + {α}_{N N} {TP}_{N}\end{matrix} \qquad [ 1 ]$$

The above system must be solved with respect to TPs. The following shows that the individual peaks' contributions are linear with respect to peaks' heights, TP, and that the coefficients α may be non-linear with respect to T_{S} and T_{E}.

### Useful Formulas

A useful expression for the Fourier Transform (FT) of the following function:

$$f ( t , {ω}_{0} ) = \{ \begin{matrix}{e}^{i {ω}_{0} t} , t ∈ [ {T}_{S} , {T}_{E} ] , \\ 0 , t < {T}_{S} , t > {T}_{E}\end{matrix}$$

is given by:

$$( ω ) = FT ( f ( t ) ) = {\int }_{- ∞}^{+ ∞} {e}^{- i ω t} * {e}^{i {ω}_{0} t} dt = {\int }_{{T}_{S}}^{{T}_{E}} {e}^{- ( i ω - i {ω}_{0} ) t} dt = \frac{{e}^{i ( {ω}_{0} - ω ) {T}_{E - e} i ( {ω}_{0} - ω ) {T}_{S}}}{i ( {ω}_{0} - ω )}$$

Introducing Δ_{ω}=ω₀−ω, LT=T_{E}−T_{S}, the last expression can be rewritten as:

$$( ω ) = FT ( f ( t ) ) = {e}^{i {Δ}_{ω} {T}_{S}} \frac{{e}^{i {Δ}_{ω} L T} - 1}{i {Δ}_{ω}} = {e}^{i {Δ}_{ω} {T}_{S}} * {e}^{\frac{i {Δ}_{ω} L T}{2}} \{ \frac{{e}^{\frac{i {Δ}_{ω} L T}{2}} - {e}^{- \frac{i {Δ}_{ω} L T}{2}}}{i {Δ}_{ω}} \} = 2 * {e}^{i {Δ}_{ω} {T}_{S}} * {e}^{\frac{i {Δ}_{ω} L T}{2}} * \frac{sin \frac{{Δ}_{ω} L T}{2}}{{Δ}_{ω}} = 2 * {e}^{\frac{i {Δ}_{ω} {T}_{C}}{2}} * \frac{sin \frac{{Δ}_{ω} L T}{2}}{{Δ}_{ω}} ,$$

$$Here :$$

$${T}_{C} = \frac{{T}_{S} + {T}_{E}}{2} , LT = {T}_{E} - {T}_{S} , {Δ}_{ω} = {ω}_{0} - ω$$

The above expression allows us to deduce another useful formula for the FT of cos(wot) defined in the same interval t ∈ [T_{S},T_{E}], as:

$$( ω ) = F T ( cos ( {ω}_{0} t ) ) = {e}^{i {Δ}_{ω}^{-} {T}_{C}} * \frac{sin \frac{{Δ}_{ω}^{-} LT}{2}}{{Δ}_{ω}^{-}} + {e}^{- i {Δ}_{ω}^{+} {T}_{C}} * \frac{sin \frac{{Δ}_{ω}^{-} LT}{2}}{{Δ}_{ω}^{-}}$$

$$Here :$$

$${T}_{C} = \frac{{T}_{S} + {T}_{E}}{2} , LT = {T}_{E} - {T}_{S} , {Δ}_{ω}^{-} = {ω}_{0} - ω , {Δ}_{ω}^{+} = {ω}_{0} + ω$$

For the frequency ranges of our interest, we may stipulate:

$$\frac{1}{{Δ}_{ω}^{+}} ≪ 1$$

As a result, the second term in the above FT formula is negligibly small (<10⁻⁶), and so for practical purposes one may use only the first term, as follows:

$$( ω ) = F T ( cos ( {ω}_{0} t ) ) = {e}^{i {Δ}_{ω}^{-} {T}_{C}} * \frac{sin \frac{{Δ}_{ω}^{-} LT}{2}}{{Δ}_{ω}^{-}}$$

When T_{C}=0, the above formula gives us the very well know sinc-function, that has the value of LT/2 at ω=ω₀. The above formula for a signal with an initial phase ϕ and an amplitude A_{ω}_{₀} transforms into:

$$\begin{matrix}( ω ) = FT ( {A}_{{ω}_{0}} * cos ( {ω}_{0} t + φ ) ) = {A}_{{ω}_{0}} * {e}^{i φ} * {e}^{i {Δ}_{ω}^{-} {T}_{C}} * \frac{sin \frac{{Δ}_{ω}^{-} LT}{2}}{{Δ}_{ω}^{-}} \\ = {A}_{{ω}_{0}} * {e}^{i φ} * {e}^{\frac{i ( {ω}_{0} - ω ) ( {T}_{S} + {T}_{E} )}{2}} * \frac{sin \frac{( {ω}_{0} - ω ) ( {T}_{E} - {T}_{S} )}{2}}{{ω}_{0} - ω}\end{matrix} \qquad [ 2 ]$$

The above a general approximation of the FT of: A_{ω}_{₀}*cos(ω₀t+φ). This formula allows us to obtain a value of: A_{ω}_{₀}*cos(ω₀t+φ) at any given frequency ω of a Fourier spectrum. This, in turn, allows us to estimate contributions from nearby peaks.

### A Simple Case

Assume that we have N ions. The signal from each ion is represented by a single harmonic at ωₖ, all ions are assumed to have the same phase (to simplify formulas, we assume φ=0, but this is not necessary as long as the phase is the same for all ions), all ions are assumed to exist from the beginning of the transient (T_{S}=0) and do not die so that all ions have the same T_{E} that is equal to the length of the transient. All following considerations are easily extended to a scenario where each ion's signal is represented by several harmonics. Then, the frequency spectrum of an ion oscillating at ωₖ is given by:

$$( ω ) = {A}_{{ω}_{k}} * {e}^{\frac{i ( {ω}_{k} - ω ) {T}_{E}}{2}} * \frac{sin \frac{( {ω}_{k} - ω ) {T}_{E}}{2}}{{ω}_{k} - ω}$$

Comparing this formula with the system of equations [1], we can see that if ωₖ and T_{E} are known and fixed, one can calculate all coefficients α for a given frequency ωₘ. In other words, one may calculate the contribution factor, αₘₖ, of an ion oscillating at ωₖ to the spectral component corresponding to the ion oscillating at ωₘ, as follows:

$${α}_{m k} = {e}^{\frac{i ( {ω}_{k} - {ω}_{m} ) {T}_{E}}{2}} * \frac{sin \frac{( {ω}_{k} - {ω}_{m} ) {T}_{E}}{2}}{{ω}_{k} - {ω}_{m}}$$

The system becomes linear with respect to unknown A_{ω}_{ₖ} and may be solved. In other words, the A_{ω}_{ₖ} are the TPₖ (k=1 to N) we require from equation [1] above.

In practice, due to the noise in the input signal and, therefore, inaccurate estimates of 0Pₖ in equations [1], it may be preferable to take spectral values at several points around each ion's peak at several harmonic frequencies and search for a combination of A_{ω}_{ₖ} that delivers the best fit on equation [1] (in terms of the least squares, for example).

### Another Example

In some experiments an ion may be ‘born’ in the middle of an image-charge current signal transient. These so-called ‘secondary ions’ will have different and unknown values of T_{S}, T_{E} and φ. As can be seen from equation [2], the system becomes non-linear with respect to these new unknowns. The phase term:

$${e}^{i φ} * {e}^{\frac{i ( {ω}_{0} - ω ) ( {T}_{S} + {T}_{E} )}{2}}$$

in equation [2] does not have a unique solution. In other words, the same value of this term can be delivered by different combinations of φ, T_{S} and T_{E}. This reflects the fact that the FT spectrum shows which frequency components exist in the signal but does not identify when they appear or for how long they exist. There are known standard approaches to solving systems of non-linear equations, for example, the Levenberg-Marquardt method, which are readily available to the skilled person. However, this method requires that the minimization function has a non-zero second derivative in the region of minimization, and this condition may not be satisfied in all cases.

The inventors have found that a numerical approach may be used particularly successfully in which the unknown variables are varied within predefined ranges with by predefined step sizes.

For example, in general, the lifetime, LT, (LT=T_{E}−T_{S}) values may be varied by varying T_{E} in the range of −45 ms≤T_{E}≤+45 ms around an estimated values of T_{E}. This variation may be implemented in step sizes of about 1 ms. Of course, other ranges and/or step-sizes may be employed, if desired.

For example, in general, the amplitudes, A_{ω}_{₀}, may be varied in the range 0.80≤A_{ω}_{₀}≤1.20. This variation may be implemented in step sizes of about 0.01. For example, an amplitude value of 1 may correspond to a charge of 50e. Of course, other ranges and/or step-sizes may be employed, if desired.

At each step of variation, a sum of squares of differences between the measured values and the analytical (model) values is calculated. The combination of unknowns that delivers the minimal sum of squares of differences is accepted as the solution of equations [1].

### REFERENCES

A number of publications are cited above in order to more fully describe and disclose the invention and the state of the art to which the invention pertains. Full citations for these references are provided below. The entirety of each of these references is incorporated herein.
Jared O. Kafader, “STORI Plots Enable Accurate Tracking of Individual Ion Signals”; J. Am. Soc. Mass Spectrum (2019) 30: 2200-2203
“High-Capacity Electrostatic Ion Trap with Mass Resolving Power Boosted by High-Order Harmonics”: by Li Ding and Aleksandr Rusinov, Anal. Chem. 2019, 91, 12, 7595-7602.
W. Shockley: “Currents to Conductors Induced by a Moving Point Charge”, Journal of Applied Physics 9, 635 (1938)]
S. Ramo: “Currents Induced by Electron Motion”, Proceedings of the IRE, Volume 27, Issue 9, September 1939
WO02/103747 (A1) (Zajfman et al.)
WO2012/116765 (A1) (Ding et al.)

1. A method of processing an image-charge/current signal representative of one or more ions undergoing oscillatory motion within an ion analyser apparatus, the method comprising:
obtaining a recording of the image-charge/current signal generated by the ion analyser apparatus in the time domain;
by a signal processing unit:
applying a transform of the recorded signal to provide a frequency-domain signal;
selecting N (where N is an integer>1) separate values (OPₙ, where n=1 to N; N≥M) of the frequency-domain signal each from amongst a plurality of separate adjacent signal peaks of the frequency-domain signal which include a signal peak corresponding to a target ion; and, solving a system of equations:
$${OP}_{n} = {\sum }_{m = 1}^{M} {α}_{n m} \times {TP}_{m} , for n = 1 to N ; N \geq M$$
where αₙₘ are coefficients and TPₘ are corrected values of M of the selected N separate values of the frequency-domain signal;
selecting the corrected value (TPₘ) from amongst the M corrected values of the frequency-domain signal corresponding to a signal peak (e.g. a harmonic peak) associated with the target ion;
calculating a value representative of the charge of said target ion undergoing oscillatory motion within the ion analyser apparatus based on the selected corrected value (TPₘ).

2. A method according to claim 1 wherein at least one of the selected N separate values of the frequency-domain signal corresponds to a respective adjacent signal peak which resides at a frequency that is not a harmonic frequency of target ion.

3. A method according to claim 1 wherein, before said step of applying a transform of the recorded signal to provide a frequency-domain signal:
determining a value for the period of a periodic signal component within the recorded signal;
truncating the recorded signal to provide a truncated signal having a duration substantially equal to an integer multiple of said period; and subsequently,
performing said step of applying a transform of the recorded signal in which the recorded signal is the truncated signal, to provide said frequency-domain signal; whereby,
said step of calculating a value representative of the charge of a said target ion is based on a corrected value (TPₘ) of the frequency-domain signal corresponding to the truncated signal.

4. A method according to claim 3 wherein the duration of the truncated signal is an integer multiple of the period of the target ion oscillation.

5. A method according to claim 3 wherein the truncated signal is a sub-portion of the recorded signal which starts at a recorded time after the recorded start time of the recorded image-charge/current signal and ends at a recorded time before the recorded end time of the recorded image-charge/current signal.

6. A method according to claim 3 wherein the truncated signal is a sub-portion of the recorded signal within which a sequence of repeating signal peaks reside which each have a respective peak signal value which deviates by not more than about 20% from the value of the largest peak value amongst the sequence of repeating signal peaks.

7. A method according to claim 3 wherein said truncating the recorded signal comprises:
transforming the recorded time-domain signal in to a frequency-domain thereby to generate a transformed recorded signal;
selecting a peak value of the transformed recorded signal from within a signal peak of the transformed recorded signal corresponding to a frequency-domain harmonic component of the recorded signal;
selecting a first adjacent value of the transformed recorded signal within the signal peak and corresponding to a frequency less than the frequency associated with the peak value;
selecting a second adjacent value of the transformed recorded signal within the signal peak and corresponding to a frequency greater than the frequency associated with the peak value;
reconstructing a time-domain signal based on the selected peak value, the selected first adjacent value and the selected second adjacent value;
determining a threshold time at which an amplitude modulation within the reconstructing a time-domain signal falls below a threshold signal value;
truncating the recorded signal according to the threshold time so determined.

8. A method according to claim 7 wherein said threshold signal value is a signal value corresponding about 80% of the largest value of the amplitude modulation.

9. A method according to claim 7 wherein the frequency associated with the selected peak value is substantially equal to the frequency of the harmonic associated with the given signal peak of the transformed recorded signal.

10. A method according to claim 7 wherein the selected peak value, the selected first adjacent value and the selected second adjacent value are obtained from the spectral peak corresponding to the N^{th} harmonic of the frequency-domain harmonic components of the recorded signal, wherein N is an integer greater than one (1).

11. A method according to claim 10 wherein N=3 (three).

12. A method according to claim 7 wherein the first adjacent value is selected to correspond to a frequency that is lower than the frequency of the selected peak value by an amount not exceeding half of the full-width-at-half-maximum (FWHM) of the given signal peak of the transformed recorded signal.

13. A method according to claim 7 wherein the second adjacent value is selected to correspond to a frequency that is higher than the frequency of the selected peak value by an amount not exceeding half of the full-width-at-half-maximum (FWHM) of the given signal peak of the transformed recorded signal.

14. A method according to claim 12 wherein the first adjacent value and the second adjacent value are each selected to correspond to a respective frequency that differs from the frequency of the selected peak value by the same amount.

15. A method according to claim 1 wherein the step of reconstructing a time-domain signal based on a selected one or more frequency-domain harmonic components of the truncated signal, comprises calculating a time-domain signal using an inverse transform of the frequency-domain transform applied to the truncated time domain signal to generate said frequency-domain harmonic components of the truncated signal.

16. A method according to claim 1 wherein said value representative of the charge of a said ion is proportional to said selected corrected value (TPₘ).

17. A method according to claim 1 wherein the step of obtaining a recording of the image-charge/current signal generated by the ion analyser apparatus in the time domain includes obtaining a plurality of image charge/current signals before processing the plurality of image charge/current signals by said signal processing unit, wherein obtaining the plurality of image charge/current signals includes:
producing ions;
trapping the ions such that the trapped ions undergo oscillatory motion; and
obtaining a plurality of image charge/current signals representative of the trapped ions undergoing oscillatory motion using at least one image charge/current detector.

18. An ion analyser apparatus configured to generate an image charge/current signal representative of one or more ions undergoing oscillatory motion therein, wherein the ion analyser apparatus is configured to implement the method according to claim 1.

19. An ion analyser apparatus according to claim 18 comprising any one or more of: an ion cyclotron resonance trap; an Orbitrap® configured to use a hyper-logarithmic electric field for ion trapping; an electrostatic linear ion trap (ELIT); a quadrupole ion trap; an ion mobility analyser; a charge detection mass spectrometer (CDMS); Electrostatic Ion Beam Trap (EIBT); a Planar Orbital Frequency Analyser (POFA); or a Planar Electrostatic Ion Trap (PEIT), for generating said oscillatory motion therein.

20. An ion analyser apparatus configured for generating an image-charge/current signal representative of oscillatory motion of one or more ions received therein, the apparatus comprising:
an ion analysis chamber configured for receiving said one or more ions and for generating said image charge/current signal in response to said oscillatory motion;
a signal recording unit configured for recording the image charge/current signal as a recorded signal in the time domain;
a signal processing unit for processing the recorded signal to:
apply a transform of the recorded signal to provide a frequency-domain signal;
select N (where N is an integer>1) separate values (OPₙ, where n=1 to N; N≥M) of the frequency-domain signal each from amongst a plurality of separate adjacent signal peaks of the frequency-domain signal which include a signal peak corresponding to a target ion; and, solving a system of equations:
$${OP}_{n} = {\sum }_{m = 1}^{M} {α}_{n m} \times {TP}_{m} , for n = 1 to N ; N \geq M$$
where αₙₘ are coefficients and TPₘ are corrected values of M of the selected N separate values of the frequency-domain signal;
select the corrected value (TPₘ) from amongst the M corrected values of the frequency-domain signal corresponding to a signal peak (e.g. a harmonic peak) associated with the target ion;
calculate a value representative of the charge of said target ion undergoing oscillatory motion within the ion analyser apparatus based on the selected corrected value, (TPₘ).

21. An ion analyser apparatus according to claim 20 wherein at least one of the selected N separate values of the frequency-domain signal corresponds to a respective adjacent signal peak which resides at a frequency that is not a harmonic frequency of target ion.

22. An ion analyser apparatus according to claim 20 wherein the signal processing unit is configured for processing the recorded signal to:
determine a value for the period of a periodic signal component within the recorded signal;
truncate the recorded signal to provide a truncated signal having a duration substantially equal to an integer multiple of said period;
perform said step of applying a transform of the recorded signal in which the recorded signal is the truncated signal, to provide said frequency-domain signal; whereby,
said step of calculating a value representative of the charge of a said target ion is based on a corrected value (TPₘ) of the frequency-domain signal corresponding to the truncated signal.

23. An ion analyser apparatus according to claim 20 wherein the ion analyser apparatus is configured for producing ions, and the ion analysis chamber is configured for;
trapping the ions such that the trapped ions undergo oscillatory motion; and
obtaining a plurality of image charge/current signals representative of the trapped ions undergoing oscillatory motion using at least one image charge/current detector

24. An ion analyser apparatus according to claim 20 comprising any one or more of: an ion cyclotron resonance trap; an Orbitrap® configured to use a hyper-logarithmic electric field for ion trapping; an electrostatic linear ion trap (ELIT); a quadrupole ion trap; an ion mobility analyser; a charge detection mass spectrometer (CDMS); Electrostatic Ion Beam Trap (EIBT); a Planar Orbital Frequency Analyser (POFA); or a Planar Electrostatic Ion Trap (PEIT), for generating said oscillatory motion therein.

25. A computer-readable medium having computer-executable instructions configured to cause a mass spectrometry apparatus to perform a method of processing a plurality of image charge/current signals representative of trapped ions undergoing oscillatory motion, the method being according to claim 1.
